(19) United States
(12) Patent Application Publication
(10) Pub. No.: US 2003/0171990 A1
(43) Pub. Date: Sep. 11, 2003

(54) Methods, systems, and articles of manufacture for managing the delivery of content

(75) Inventors: Bejugum Venkateshwara Rao, Flower Mound, TX (US); Barry Craig Smith, Flower Mound, TX (US); Ladislav Lettovsky, Trophy Club, TX (US); Daniel Cummings Delph, Euless, TX (US); Andrew Kevin Barber, Irving, TX (US); Raghuram Trivikraman, Coppell, TX (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Sabre Inc.

(21) Appl. No.: 10/322,608

(22) Filed: Dec. 19, 2002

Related U.S. Application Data
(60) Provisional application No. 60/340,848, filed on Dec. 19, 2001.

(51) Int. Cl. G06F 17/60

(52) U.S. Cl. 705/14; 705/10

(57) ABSTRACT

Methods, systems, and articles of manufacture consistent with certain principles related to the present invention enable a computing system to manage the delivery of web content based on historical site visit data and revenue optimization processes. In one aspect consistent with certain features related to the present invention, a publisher may provide ad campaigns that target various criteria. The publisher may be configured to allocate impressions of web content based on forecasted site visits and impressions for future months. The impression allocations may be adjusted based on overlapping targeting criteria between the campaigns and a prediction of whether a campaign may reach an impression goal before the expiration of the campaign's run period. The impression allocations are also adjusted by expected revenue from clicks and revenue per impression for different campaigns.

### CROSS-REFERENCE TO RELATED APPLICATIONS

This application claims the benefit of U.S. Provisional Application Serial No. 60/340,848 entitled, Sabre Virtually there Ad Forecasting and Allocation, filed Dec. 19, 2001, owned by the assignee of this application and expressly incorporated herein by reference in its entirety.

### DESCRIPTION OF THE INVENTION

1. Field of the Invention

This invention relates to content provision environments, and more particularly, to methods, systems, and articles of manufacture for forecasting and allocating content for a server.

2. Background of the Invention

Since the inception of the Internet, information related to many different topics has been made available to users in increasing numbers. Because users may access a wide variety of information through the Internet, on-line advertising has become a growing and lucrative business. The key players in this business typically include a provider, which, for example, may request to have information advertised, and a publisher, which, for example, provides the infrastructure for delivery of the information on-line. After determining the type of advertisements to provide for a provider, the publisher may provide information associated with these advertisements to an advertisement server (ad server). The ad server may render content reflecting the advertisements in a document, such as a web page, associated with a particular server. A user that accesses a web page using an application like a browser, such as Microsoft's Internet Explorer, may be presented with the advertisements that are included in the web page.

Generally, users are presented with the content delivered in web pages while “browsing” the Internet. Providers identify these users as potential consumers for their products and services. Accordingly, providers have an interest in targeting selected users for products and services. To tap into this interest, publishers may track user interactions based on visits, sales, buying trends, and product/service preferences at the user level. Using this user-based information, the publisher may target specific users with advertisements that correlate with their characteristics. This advertising technique is known as target or contextual advertising.

Publishers typically charge providers for specialized advertising services like target advertising, based on various pricing models. These pricing models may include Cost Per iMpression (CPM) and Cost Per Click (CPC) models. A CPM model is a pricing model for content delivery environments that enables a publisher to charge a provider for a predetermined number of impressions of an advertisement rendered on a web page, such as $50 for every 1000 impressions. A CPC model, on the other hand, is a pricing model that allows a publisher to charge the provider a fee for every “click-through” detected on a rendered advertisement. A “click-through” is associated with a user activity of selecting an activated hyperlink, icon, etc., that is provided in the advertisement rendered on the web page. For instance, an advertisement rendered on a web page managed by the publisher may include a hyperlink to another web page maintained by the provider. When a user selects the hyperlink, using an input device such as a mouse, the selection is considered a “click-through.”

Both the publisher and provider take risks using both the CPM and CPC models. For example, a publisher runs a risk of losing revenue when incorporating a complete CPC model because the costs of providing the advertisement in a marketable position of a web page may exceed the revenue received from a certain number of “click-throughs.” Alternatively, the CPM model favors the publisher because revenue is generated simply by rendering the advertisement on the web page a predetermined number of times. The provider runs a risk of losing revenue in a CPM model because having an advertisement rendered on a web page provides no indication of the effectiveness of its position on the web page. Because of these risk-related discrepancies, another pricing model, known as a hybrid pricing model, has been introduced as a compromise between providers and publishers for sharing some of the risks involved with on-line advertising. The hybrid model allows providers to pay a fee based on a predetermined number of impressions and a bonus fee for each click-though.

Because providers typically contract for a predetermined number of renderings of an advertisement over a period of time, the publisher bears the burden of ensuring that the rendering goal is achieved. A problem that publishers may encounter is associated with the failure to recognize when a rendering goal may not be met until late in the contract period. For example, suppose a provider purchased a location on a web page for 20,000 renderings of an advertisement for a three month period. Depending on the situation, the publisher may not realize until the second month that the 20,000 goal may not be achieved based on the rate the advertisement has been previously rendered. When the publisher is providing a substantial number of other advertisements for other providers, adjusting the rendering rate for the purchased advertisement may not be possible. Accordingly, the publisher may not meet the purchased goal of 20,000, and thus not only lose revenue, but perhaps future business with the provider.

### SUMMARY OF THE INVENTION

It is therefore desirable to have a method and system that allows a publisher to forecast future web site visits by target criteria, and allocate content renderings based on the forecasted information to ensure rendering goals are substantially achieved.

Methods, systems and articles of manufacture consistent with features of the present invention enable a computing system to manage the delivery of content and to maximize revenue in return for delivery of the content. In one embodiment, a method is provided that includes storing historical data reflecting previous access or attempts to access at least one of the documents. Future traffic may be estimated for at least one of the documents using the stored historical data and seasonality characteristics associated with the previous access or attempts to access the at least one of the documents. The method may also include determining whether content associated with a targeting criterion may be allocated to a content delivery campaign. Based on the determination and the estimated future traffic impressions of the content may be allocated to the campaign and the content for the campaign may be delivered in accordance with the impression allocations.

### BRIEF DESCRIPTION OF THE DRAWINGS

The accompanying drawings, which are incorporated in and constitute a part of this specification, illustrate several aspects of the invention and together with the description, serve to explain the principles of the invention. In the drawings,

FIGS. 1A and 1B illustrate exemplary system environments that may be implemented by methods, systems, and articles of manufacture consistent with certain features related to the present invention;

FIG. 2 illustrates a screenshot of an exemplary web page including ad positions consistent with certain features related to the present invention;

FIG. 3 shows a flowchart of an exemplary macro forecasting process consistent with certain features related to the present invention;

FIG. 4 shows a table of macro forecasts for five exemplary future months consistent with certain features related to the present invention

FIGS. 5A and 5B show Venn diagrams of exemplary impression forecasts consistent with certain features related to the present invention;

FIG. 6 shows a flowchart of an exemplary allocation process consistent with certain features related to the present invention;

FIG. 7 shows a flowchart of an exemplary ad server process consistent with certain features related to the present invention;

FIG. 8 shows a flowchart of an exemplary allocation process consistent with certain features related to the present invention;

FIG. 9 shows an exemplary log file consistent for illustrating certain features related to the present invention;

FIG. 10 shows an exemplary awk script consistent with certain features related to the present invention;

FIG. 11 shows an exemplary impression opportunity matrix consistent with certain features related to the present invention; and

FIG. 12 shows a screen shot of an exemplary interface consistent with certain features related to the present invention.

### DETAILED DESCRIPTION

Overview

Methods, systems, and articles of manufacture consistent with certain features and principles related to the present invention enable a computing system to manage the delivery of content and to maximize revenue in return for delivery of the content. In one aspect consistent with certain features related to the present invention, a publisher may forecast an available supply of content impressions based on historical server visit data. The supply forecast may be associated with content campaigns that target particular criteria corresponding with a server visitor and/or a document that includes the content. Further, the publisher may allocate impressions of the content based on the supply forecast and impression goals associated with existing campaigns and newly requested campaigns. In one aspect of the invention, the allocations may be determined to optimize the revenue generated from running the campaigns, such as allowing more impressions to be served to campaigns with more revenue generating potential (i.e., higher costs per impression rates; higher click rate; higher costs per click).

In another aspect consistent with certain features related to the present invention, impressions may be allocated based on campaigns that have varying durations and include targeting criteria that overlap. Further, impressions may be allocated based on seasonality information. That is, more impressions may be allocated for a particular campaign as opposed to another competing campaign based on a time of year, day of week, and/or time of day the campaigns are run.

Reference will now be made in detail to the exemplary aspects of the invention, examples of which are illustrated in the accompanying drawings. Wherever possible, the same reference numbers will be used throughout the drawings to refer to the same or like parts.

The above-noted features and other aspects and principles of the present invention may be implemented in various environments. Such environments and related applications may be specially constructed for performing the various processes and operations of the invention or they may include a general purpose computer or computing platform selectively activated or reconfigured by program code to provide the necessary functionality. The processes disclosed herein are not inherently related to any particular computer or other apparatus, and may be implemented by a suitable combination of hardware, software, and/or firmware. For example, various general purpose machines may be used with programs written in accordance with teachings of the invention, or it may be more convenient to construct a specialized apparatus or system to perform the required methods and techniques.

The present invention also relates to computer readable media that include program instruction or program code for performing various computer-implemented operations based on the methods and processes of the invention. The program instructions may be those specially designed and constructed for the purposes of the invention, or they may be of the kind well-known and available to those having skill in the computer software arts. Examples of program instructions include for example machine code, such as produced by a compiler, and files containing a high level code that can be executed by the computer using, for example, an interpreter or equivalent execution engine such as an engine that that uses a JIT compiler to facilitate execution of high level code.

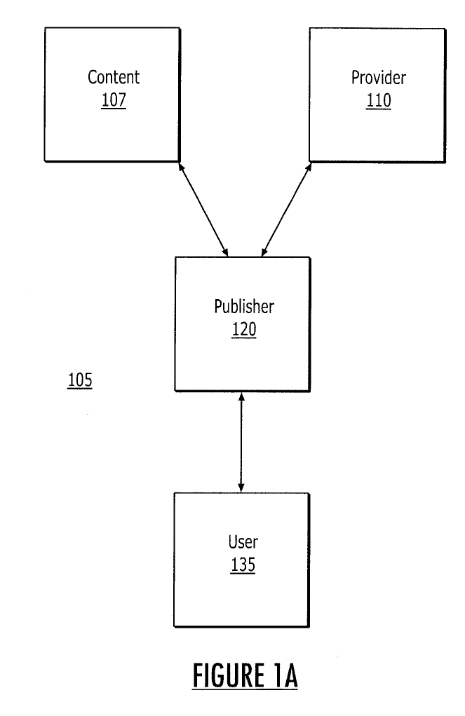

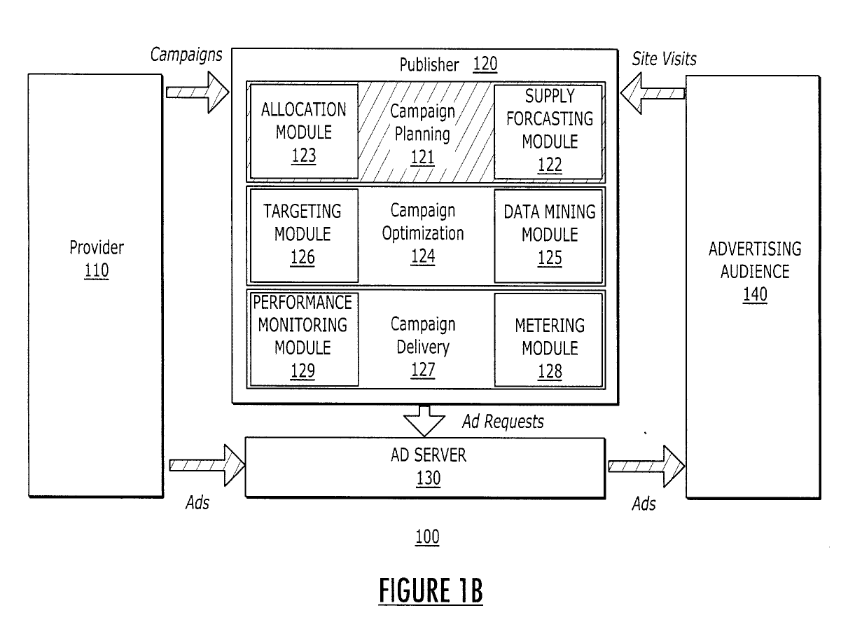

Methods, systems, and articles of manufacture consistent with features of the present invention allow a computing system to forecast future traffic associated with a set of documents (e.g., a web site, web pages, etc.) and allocate advertising campaigns to a document access manager (e.g., server providing the web site) based on the forecasted traffic. The expression “traffic” as used herein may represent the flow, or attempts of flow, of information between entities, such as a server and client entity. For example, the reception of information (e.g., access requests) from a user at a server entity that provides documents, web-based data, etc. may be considered “traffic.” Alternatively, access attempts to information provided by a computing system may be considered “traffic.” Therefore, an access attempt by a computing entity for content, for example, from a web server, may be considered as traffic. Similarly, “traffic” may represent the provision of information from a computing entity. For example, the delivery of content from a web server to a requesting computing entity may be considered “traffic.”FIG. 1A shows an exemplary system environment 105 that may be implemented by methods and system consistent with the present invention. As shown, system environment 105 may include content 107, provider 110, a publisher 120, and a user 135. Content 107 may represent a system that maintains and stores content (e.g., documents, web-based data, etc.) that is provided to user 135, directly or indirectly, such as through other entities (e.g., publisher 120). Alternatively, content 107 may represent a database that stores content that is retrieved by an external entity, such as publisher 120 and user 135.

Provider 110 may represent a computing system associated with a business entity, user, or a combination of both, that provides information that is to be published by an on-line publishing entity, such as publisher 120. The information may include, but is not limited to, advertisements of provider 110 for products and/or services. The information may be provided with the data provided by content 107 and served to user 135 directly or indirectly, such as through publisher 120, or through a network (e.g., the Internet).

Publisher 120 may represent a computing system that provides, manages, and/or maintains information that is provided to user 135. This information may include data provided by content 107, information provided by provider 110, or a combination of both. Further, publisher 120 may provide additional content, data, etc., to user 135 and may be configured to communicate with content 107 and provider 110 to perform various functions related to certain aspects associated with the present invention.

User 135 may represent a computer system operated by a single user or a group of users that exchange information with publisher 120. For example, user 135 may represent a desktop computer system operated by a user that requests and receives content in the form of web pages from publisher 120 through a browser program executing in the desktop system. Further, user 135 may also receive content from provider 110 and content 107 directly, such as through the Internet, a Local Area Network (LAN), etc.). For instance, user 135 may receive a web page from publisher 120 that includes data from content 107 and receive other content (e.g., advertisements) directly from provider 110. A browser operating in user 135 may be configured to place the provider based content in the web page before rendering the page to a user via a graphical user interface.

FIG. 1B shows another exemplary system environment 100 that may be implemented by systems and methods consistent with the present invention. System environment 100 may include a provider 110, a publisher 120, an ad server 130, and an advertising audience 140.

Provider 110 may represent a computing system similar to the provider 110 described above with respect to FIG. 1A. For example, provider 110 may be a computing system associated with a business entity, user, or a combination of both, that provides information that is to be published by an on-line publishing entity, such as publisher 120.

Ad server 130 may be a computing system configured to operate as a server or similar computing device. Further, ad server 130 may be a server configured to run and process web server software, such as Java Server Pages (JSPs), Active Server Pages (ASPs), common Gateway Interface (CGI) scripts, etc.. Ad server 130 may receive ad requests from publisher 120 and present the ads in web pages.

Members of advertising audience 140 may access these web pages by accessing the web sites that include the web pages presented by ad server 130. Advertising audience 140 may include a user, group of users, a business, group of businesses or corporations, or any other type of entity, or group of entities, that access documents (e.g., web pages) provided by publisher 120 or other entities, such as provider 110, and/or ad server 130. For example, an audience member may correspond to user 135 shown in FIG. 1A. Each time an audience member 140 accesses a server, such as publisher 120, it may be considered a site visit (i.e., server visit) in accordance with certain features related to the present invention.

Audience members may use computing systems that execute browser applications to connect to a network, such as the Internet, and access remote computing devices, such as ad server 130 and/or publisher 120. One skilled in the art would realize that audience members may access the content provided by publisher 120 and/or ad server 130 in a number of different ways, using a number of different communication techniques and protocols, such as wireless, wireline, and optical communication techniques, without departing from the scope of the invention. Further, the type of computing system associated with an audience member is not limited to any particular type of computer system, such as a desktop computer. Audience members may receive content provided by ad server 130 using any known computing device or system that is capable of accessing remote servers, such as a Personal Digital Assistant (PDA), wireless telephone, and a notebook computer.

Publisher 120 may be a computing system similar to publisher 120 shown in FIG. 1A. That is, publisher 120 may be a computing system that provides, manages, and/or maintains one or more web sites that include one or more web pages. The web sites may be industry specific and may provide web services for particular users, types of users, businesses, or types of businesses. Publisher 120 may include computing components that enables it to interact with provider 110, ad server 130, and audience 140 in accordance with certain features related to the present invention. For example, publisher may include one or more processors, memories, I/O devices, interfaces, etc. that work collectively and/or independently to perform certain functions consistent with aspects of the present invention. Further, publisher 120 may be a distributed system that includes components that are physically separated and connected by communication paths, such as a local area network, wide area network, buses, backplanes, etc. Additionally, publisher 120 may be associated with a user, group of users, a business, and/or a group of businesses that use the features of the computing components of publisher 120 to perform certain tasks consistent with certain aspects of the present invention.

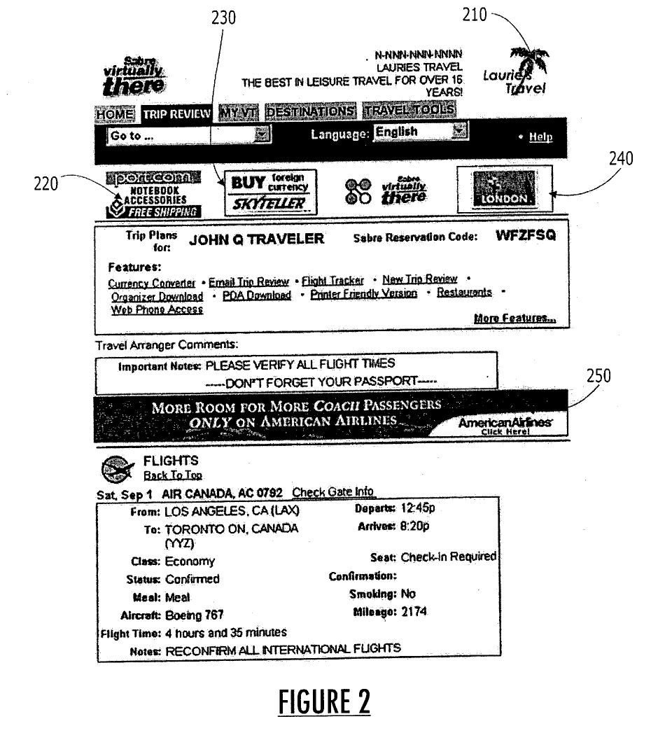

In accordance with one aspect consistent with certain features related to the present invention, publisher 120 (such as entities associated with publisher 120) may market space on one or more documents, such as interactive television documents, web pages, etc. The space may be used by an entity for presenting content for a fee payable to publisher 120. Accordingly, publisher 120 may sell ad campaigns to provider 110. An ad campaign may be a plan for presenting advertisements for provider 110 based on criteria associated with the web page, and perhaps the profile of potential users that visit the web page. For example, FIG. 2 shows a screen shot of an exemplary web page 200 provided by publisher 120 that may be associated with a business entity working in the travel industry. Web page 200 may include, among other types of information, five banner ad positions 210-250. Similarly there may be ad positions on other web pages (home, destination, and travel tools pages, all not shown). Provider 110 may target potential customers by purchasing impressions in these ad positions 210-250. An impression may be an opportunity to provide content in a position on a document (e.g., web page), such as an ad position. An available supply of impressions depends on future site visits and targeting criterion, which are forecasted in accordance with one aspect consistent with certain features related to the present invention. It should be noted that although publisher 120 and provider 110 are described herein as being associated with the travel industry, one skilled in the art would realize that publisher 120 and provider 110 may be associated with any type of industry and may provide web pages and sites that are also associated with any type of industry or market.

Publisher 120 may sell campaigns and impression goals to one or more providers, such as provider 110, and load the campaign related information into ad server 130. Campaign related information may include profile data associated with the type of content that is provided to audience 140, the profile of the audience 140 receiving the content, and any other characteristic profile information associated with a campaign managed by publisher 120. The loading of campaign related information (or any other type information or data) may include ad server 130 retrieving this information from publisher 120 or publisher 120 pushing the information to ad server 130. Further, publisher 120 may provide program code that is provided to ad server 130. The program code may be provided in a document delivered to a user's browser program running on a computer. The program code, when executed, may direct the user's browser to insert content from other sources, such as other web sites. In one aspect of the invention, there may be multiple campaigns that are active in publisher 120. Each campaign may have its own targeting criterion, which is a characteristic profile associated with the campaign. Further, each web site provided by publisher 120 may have targetable elements, known as visit parameters that may depend on the type of web site provided by publisher 120. In one aspect consistent with certain features related to the present invention, the visit parameters may include trip characteristics, such as Passenger Name Record (PNR) elements, trip history, demographics, and (declared, compiled) profile data. Also, more than one campaign may qualify for targeting ad messages in the same ad position. This results in an ad collision. To avoid ad collisions, forecasted impressions may be allocated to competing campaigns and each impression may be allocated to at most one campaign.

Publisher 100 may include, among other things, a campaign planning module 121, a campaign optimization module 124, and a campaign delivery module 127. A “module” as used herein may be a unit that includes processing components that collectively may perform functions consistent with certain features related to the present invention. For example, each module 121, 124, and 127 may include one or more microprocessors, memory devices, and supporting elements (e.g., memory controllers, bus interfaces, etc.). The one or more memory devices included in a module may include software that, when executed by a processor device, performs certain processes consistent with the present invention. Alternatively, a module may be software (e.g., program instructions) that, when executed by one or more processing devices in publisher 120, performs functions consistent with certain features related to the present invention.

In one aspect of the invention, campaign planning module 121 may determine and define one or more campaigns for provider 110. A campaign may be an environment represented by a data structure that reflects services that publisher 120 may perform for provider 110, such as an ad campaign. A campaign may be associated with one or more parameters, including start and end dates, targeting criteria, impression goals and budget constraints. Start and end dates for a campaign may be designated by a particular date, such as Nov. 1, 2002, or may be further designated by a particular date and time, such as Nov. 1, 2002, 1400 hours (2:00 PM). Targeting criteria may be characteristics associated with content (e.g., a web page) associated with a campaign, a user accessing the site, and any other attribute that publisher 120 may determine is useful in filtering a campaign into specific target areas of interest. An impression goal may be a predetermined number of impressions associated with a campaign. For example, a campaign may have an impression goal of 20,000 impressions to be delivered over a predetermined period of time defined by the campaign's start and end dates.

Campaign planning module 121 may be configured to determine an impression goal for prospective campaigns, which are campaigns that have not been contracted (or activated) between publisher 120 and provider 110, but have been requested by provider 110 nonetheless. Campaign planning module 121 may determine an impression goal based on the parameters associated with a campaign. For example, module 121 may determine an impression goal for a prospective campaign based on the duration of a campaign (e.g., start and end dates), targeting criterion, a percentage of visits that meet the targeting criterion, impressions committed to existing campaigns, and allocation rules for ad collisions with overlapping campaigns.

In one aspect of the invention, campaign planning module 121 may include a supply forecasting module 122 and an allocation module 123. Modules 122 and 123 may be a processing unit as described above (e.g., processing device, memory device with software, etc.) Alternatively, modules 122 and 123 may be software that, when executed by a processing device, perform functions consistent with certain aspects of the present invention. Supply forecasting module 122 may determine an impression forecast for targeting areas associated with each campaign, including prospective campaigns. Further, supply forecasting module 122 may determine macro forecasts for certain periods of time, such as months, quarters, semi-annual blocks of time, etc., to determine an impression forecast. A macro forecast may be a representation of predicted visits of a location (e.g., web site) for one or more future periods of time. Allocation module 123 may determine impression allocations for active and prospective campaigns associated with provider 110. Module 123 may determine impression allocations based on data provided by supply forecasting module 122. Allocation module 123 may also determine impression allocations for any other providers that publisher 120 may have contracted to provide content delivery services.

Campaign optimization module 124 may optimize campaigns by, for example, determining how to increase revenue based on impression allocation and delivery. Publisher 120 and/or ad server 130 may implement these procedures to achieve the increase in revenue. Campaign optimization module 124 may optimize campaigns by identifying site visits that may have a higher propensity for a click-through for each campaign, and targets campaigns according to the identified click-through propensities. Module 124 may identify the higher click-through site visits based on, for example, historical site visit data for one or more sites. Campaign optimization module 124 may include a datamining module 125 and a targeting module 126. Modules 125 and 126 may each be a processing unit as described above (e.g., processing device, memory device with software, etc.). Alternatively, modules 125 and 126 may be software that, when executed by a processing device, perform functions consistent with certain aspects of the present invention. Datamining module 125 may determine and generate predictive models for click-through probabilities based on historical site visit data. These predictive models may be provided to targeting module 126 along with corresponding impression goals. Target module 126 may determine priorities for serving impressions to various campaigns.

Campaign delivery module 127 may allocate site visits to campaigns according to the priorities computed by the targeting module 126. Delivery module 127 may include a metering module 128 and performance monitoring module 129. Modules 128 and 129 may each be a processing unit as described above (e.g., processing device, memory device with software, etc.) Alternatively, modules 128 and 129 may be software that, when executed by a processing device, perform functions consistent with certain aspects of the present invention. Metering module 128 may provide impressions to ad server 130 according to a dynamic priority table associated with the campaigns. Further metering module 128 may track the number of impressions served and click-throughs registered with publisher 120. Performance monitoring module 129 may perform corrective actions during impression delivery operations. For example, in one aspect of the invention, performance monitoring module 129 may alert publisher 120 of low click-through rates to allow corrective actions to be taken by publisher 120 to meet impression or click-through rate goals.

Although not shown, one skilled in the art would realize that publisher 120, provider 110, ad server 130 and audience 140 may be interconnected to each other through a common network, or separate networks or communication paths, without departing from the scope of the invention. For example, ad server 130 and publisher 120 may be interconnected through a Local Area Network, while provider 110 may be interconnected to publisher 120 and ad server 130 through a common network, such as the Internet. Alternatively, ad server 130 and publisher 120 may be a single entity that performs the respective functions associated with publisher 120 and server 130. It should be noted that the manner by which the elements in system environment 100 communicate is not limited to the above examples and any type of communication path, network, or link may be incorporated by system environment 100 to facilitate communications between the elements depicted in FIG. 1 without departing from the scope of the invention. For example, audience members 140 may be connected to publisher 120 and ad server 130 through the Internet. Further, one skilled in the art would appreciate that the configuration and/or architecture of the modules included in publisher 120 is not limited to the examples described above without departing from the scope of the invention. For example, the individual modules included in publisher 120 may be located in separate computing systems that may or may not interact with other computing modules through known communication links and protocols.

As described, campaign planning module 121 may perform supply forecasting functions through supply forecasting module 122 in order to determine site visit forecasts for campaigns. In one aspect of the invention, supply forecasting may be performed in two stages: (1) macro-forecasting, and (2) forecasting based on targeting criterion.

A macro forecast may be a prediction of visits to a particular site for a future period of time. Publisher 120 may use macro forecasts to determine a number of impressions to allocate to particular locations on one or more web pages. The location for an impression may depend on the type of web page and available locations in the respective page. For example, an ad position on a home web page associated with a web site may have more impressions available than a sub-page associated with the same site because the home page may receive more site visits than the sub-page. For instance, consider an area located in a vehicle section of a travel itinerary web page that provides on-line itinerary information for a booked traveler. This page may be populated with ads only if there is no vehicle booking in the itinerary. On the other hand, another area in the page may not have such restrictions and thus may be populated for all types of site visits to the itinerary page. Consequently, the non-restricted area on the web page may have more impression opportunities than the restricted vehicle section area.

Various factors may affect how publisher 120 determines a macro forecast of site visits. For example, the type of web sites provided by ad server 130 and the type of industry associated with publisher 120 and provider 110 may affect how macro forecasts are determined by publisher 120. In one aspect consistent with certain features related to the present invention, publisher 120 may be associated with the travel industry and provides a travel-based website used by confirmed travelers (e.g., travelers that have already booked a travel itinerary with travel providers). The travel-based web site may provide a traveler with customized itinerary information regarding flights, gate assignments, tour, rail, cruise, hotels, rental cars, and weather associated with the travel plans for the traveler. An example of this type of web site may be the “Sabre Virtually There™” web site provided by Sabre Inc.™

In a travel industry environment, such as the exemplary travel industry based publisher 120 described above, macro forecasting may be affected by system configuration, changes in the number of entities using services associated with the travel industry based web site, and information delivery services. For example, the addition of new travel providers (e.g., airlines, travel agencies) that may be in partnership with publisher 120 to provide customized itinerary information for their booked travelers may affect how publisher 120 determines a macro forecast. The increase in travel providers, also known as host expansion, may increase the number of site visits to a travel-based web site, which in turn increases the number of impression opportunities for providers that are associated with publisher 120. Further, an increase in the number of entities that use the services of the travel web site may increase the number of visits to the web site. Additionally, the delivery of information to customers of the travel industry may increase site visits, which in turn will affect how publisher 120 determines a macro forecast for the site. For example, travel providers may provide e-mail messages to travel customers that include information associated with the customer's booked travel plans. These e-mail messages may result in an increase in site visits to the travel-based web site because the notified customers may visit the web site to view their respective booked information.

Macro forecasting may also depend on other factors corresponding to the industry that provider 110 and/or publisher 120 are associated. For example, in the travel industry, the seasonality of the travel market may affect macro forecasts performed by supply forecasting module 122. Because travel tends to peak in summer and slows down in winter, visits to the travel-industry based web site may increase in the summer and decrease in the winter. Further, because more people tend to travel around holidays and special events such as the SuperBowl, site visits may also increase during these periods of time.

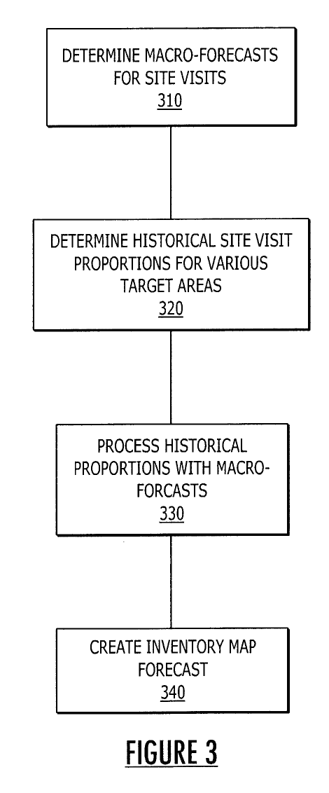

FIG. 3 shows a flowchart of an exemplary macro forecasting process that may be performed by publisher 120 in accordance with certain features related to the present invention. As shown, publisher 120 may determine one or more macro forecast by determining seasonality factors for each period of time that is to be forecasted (Step 310). For example, publisher 120 may determine monthly seasonality factors for each month to be forecasted. Alternatively, a semi-annual seasonality factor for a 6 month time period to be forecasted may be determined by publisher 120.

In one aspect consistent with certain features related to the present invention, publisher 120 may determine a seasonality factor by obtaining planned travel bookings that are projected for a target month and converting the monthly absolute numbers to a percent of total travel bookings for the year. The monthly percent of total figures are used by publisher 120 as a “monthly seasonality factor” in the site visit macro forecasting process. For example, the seasonality factor for December 2002 may be given by:

$$Monthly seasonality factor for Dec 2002 = \frac{Travel bookings for Dec 2002}{Total annual Travel bookings for 2002}$$

Once the monthly seasonality factor for the target month is determined, publisher 120 may determine a monthly seasonally adjusted growth rate (Step 320). Publisher may determine the growth rate by collecting monthly site visits observed for one month and four months previous to the month the forecast process may be performed. For example, to forecast site visits for December 2002 in November 2002, the actual monthly site visits for October 2002 and July 2002 may be collected by publisher 120. One skilled in the art would appreciate that other combinations of previous monthly site visits may be collected without departing from the scope of the invention. For example, publisher 120 may collect monthly site visits observed for two and six months ago, three and four months ago, etc. Publisher 120 may convert the collected monthly site visit data into an annualized figure by dividing the monthly site visits by the monthly seasonality factor. For example, suppose 4,136,794 and 4,209,008 site visits were recorded during July and October 2002, respectively. Further suppose that the seasonality factors for July and October 2002 are 9.18% and 8.4%, respectively. Publisher 120 may use this exemplary information to determine the following annualized site visit values:

$$\begin{matrix}\begin{matrix}Annualized site visits for Jul 2002 = \frac{Jul 2002 site visits}{\begin{matrix}Monthly seasonality factor \\ for Jul 2002\end{matrix}} \\ = 45 , 063 , 115\end{matrix} \\ \begin{matrix}Annualized site visits for Oct 2002 = \frac{Oct 2002 site visits}{\begin{matrix}Monthly seasonality factor \\ for Oct 2002\end{matrix}} \\ = 50 , 107 , 240.\end{matrix}\end{matrix}$$

A trailing three month seasonally adjusted compound monthly growth rate (x) may then be determined as follows:

$$x = {( \frac{Annualized visits for the last month}{Annualized visits four months ago} )}^{1 / 3} - 1$$

Using the above equation during November 2002, publisher 120 may determine the exemplary trailing three-month seasonally adjusted compound monthly growth rate as:

$${( \frac{50 , 107 , 240}{45 , 063 , 115} )}^{1 / 3} - 1 = 14.1 \%$$

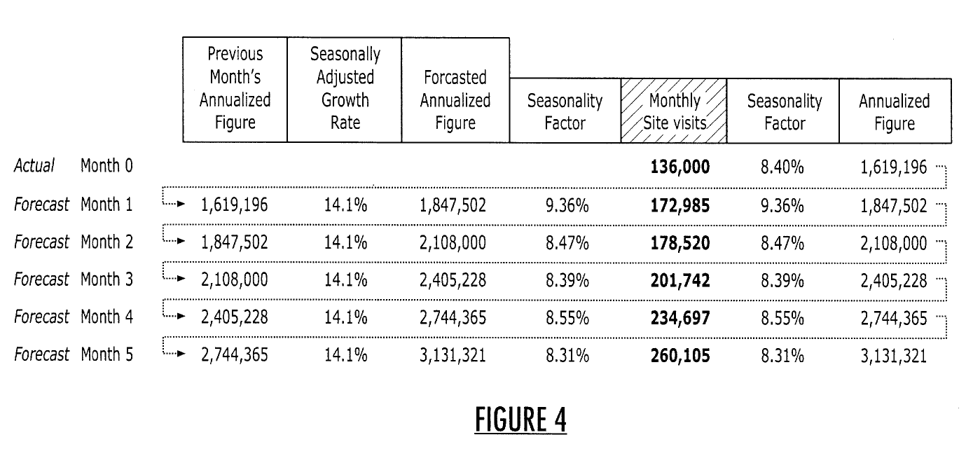

Once the seasonally adjusted growth rate is determined, publisher 120 may then apply the growth rate and the seasonality factors to historical site visits to determine a forecasted site visit for a target month (Step 330). In one aspect consistent with certain features related to the present invention, publisher 120 may determine the site traffic for a first future target month by multiplying an annualized site visit value for the target month by (1+the monthly seasonally adjusted growth rate). Publisher 120 may convert the product to a monthly figure by multiplying the product by the appropriate seasonality factor for the forecasted target month. To forecast a second future month subsequent to the first future month, publisher 120 may substitute the actual site visits and seasonality factor for the previous month with the forecast determined for the first target month and its respective seasonality factor. The same process may be repeated for additional future months to determine their respective forecasted site visits. FIG. 4 shows a table including values produced for an exemplary five month future forecast in accordance with certain aspects related to the present invention.

The other stage in the supply forecasting process includes forecasting available impressions based on targeting criterion. In one aspect of the present invention, campaigns may be targeted based on characteristics, such as the type of web page a campaign is associated, and the location and size of the advertisement positions on a web page. Also, campaigns may be targeted based on trip characteristics and demographics associated with the traveler that accessed the travel-based web site.

In one aspect consistent with the present invention, for a web site that is configured to provide services to travelers who have booked travel itineraries with selected travel providers, the trip characteristics and demographics may include, for example, indications reflecting whether the traveler booked a hotel and/or a rental car, airline codes (codes that represent individual airline carriers), an indication of an embarkation city (airport code, country, state), embarkation date (date, month), arrival date (date, month), whether an overnight stay is indicated, an indication of arrival cities (connection, overnight stay airports, dates of arrivals, days of arrivals), class of service codes (first class, business class, coach), gender of travelers (male/female), pseudo-city codes (e.g., travel agency/sub-agency that made the booking on behalf of the traveler), prime host (e.g., computer reservation system) codes, hotel property codes, and a number of passengers on the PNR associated with the traveler. Further, campaigns may be targeted based on other PNR elements (in total there may be about 100 PNR elements), calculated PNR elements, such as stop over duration, geographic location based on home phone number, temperature at the destination etc., arranger elements that may reflect an entity or entities that arranged a travel itinerary for the traveler, such as a travel agent, session characteristics, such as PC/Mac, operating system type, browser type, and IP address, traveler profile information, historical information associated with the traveler (using a PNR data warehouse), and appended data such as demographic information.

In accordance with one aspect consistent with certain principles related to the present invention, the number of impressions available for a campaign may depend on targeting criterion, duration of the campaign (begin date and end date), and the macro forecasts of site visits to the host web page on which the ad is placed.

To determine an impression forecast for a campaign, publisher 120 may utilize a macro forecast for a target month and historical site visit information for the host web page. In one aspect consistent with the present invention, publisher 120 may create an inventory map that facilitates an impression forecast for each campaign managed by publisher 120. To further illustrate the concept of impression forecasting in accordance with this aspect of the invention, consider an exemplary campaign targeting airline departures from a certain city (embarkation city code (ECY)) in a specified ad position on a travel-based Itinerary page. Further consider that the following information is available to publisher 120. The macro forecast for the itinerary page visits for a future month, for example November 2002, is 4,761,905. The historical proportion of site visits that result in successful retrievals of targetable elements may have been determined to be 84%. A successful retrieval of targetable elements may be associated with a condition when a site visitor provides correct identification data and the corresponding targetable elements for the record can be retrieved. When a site visitor provides incorrect identification information, the targetable elements may not be retrieved. This may result in an error condition. Error conditions may occur about 16% of time. If the identification information is correctly provided by a site visitor, then the targetable elements may be successfully retrieved from their respective source, such as a PNR database. A successful PNR (e.g., targetable element) retrieval may be referred to as a successful log, or a PNR okay. The historical proportion of PNR okays (successful logs) for selected targeting criterion desired by a campaign may be determined based on historical data associated with the criterion. For example, the historical proportion of PNR okays for an embarkation city (ECY) equal to Dallas Fort Worth (DFW) may be 25%.

In addition to historical proportion data, conversion factors of page visits to impressions may be taken into account by methods and systems consistent with certain features related to the present invention. For instance, site visitors may navigate on a web site from one web page to another. During this navigation, the visitor may revisit some pages. If the revisited page is not in the visitor's browser's cache, a new ad request may be issued to the ad server. This results in the delivery of a new ad impression for the same visit, thus making the number of impressions greater than site visits. An exemplary conversion factor from web page visits to impressions may be 1.25.

Based on the above exemplary information, publisher 120 may determine the impression forecast for the exemplary campaign, where the targeting criterion is ECY=DFW, which reflects an embarkation city of Dallas Fort Worth (DFW). In one aspect consistent with certain features related to the present invention, publisher 120 may determine an impression forecast based on the following formula:

Macro forecast×percent PNR okays×historical proportion×conversion factor.

Accordingly, an impression forecast for the exemplary campaign with a targeting criterion of ECY=DFW (i.e., a campaign that targets departures out of DFW) may be:

4,761,905×0.84×0.25×1.25=1.25 million (mm) impressions.

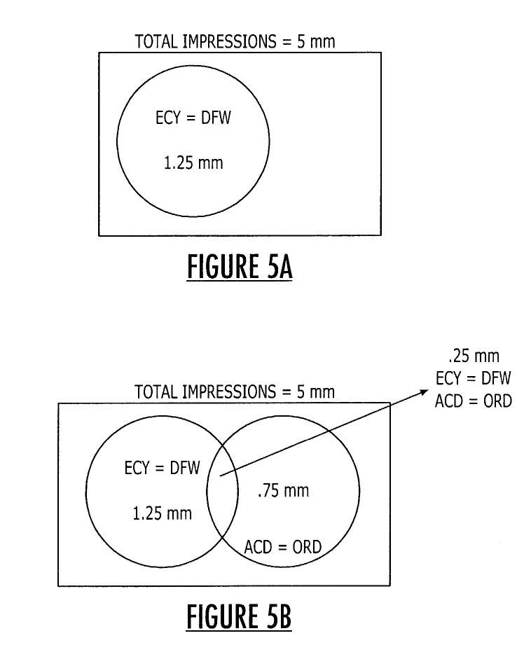

When provider 110 issues a request for a new campaign with new targeting criterion, such as targeting arrivals into a particular city (arrival city, ACD=‘ORD’), site visits that embark in DFW and arrive in ORD may be targeted for either of the two campaigns. This results in ad collisions. FIG. 5A depicts a Venn diagram of a first campaign targeting departures out of embarkation city Dallas Fort Worth (i.e., ECY=DFW) before the request for the ORD campaign is received and processed by publisher 120. FIG. 5B depicts the Venn diagram considering the new ORD campaign. As shown in FIGS. 5A and 5B, the total number of impressions are (4,761,905×0.84×1.25=) 5,000,000. Table 2 shows a breakdown of impression forecasts based on the targeting criterion depicted in FIG. 4B. The break down is referred to as an inventory map forecast.

TABLE 2
Inventory map forecast for DFW and ORD campaigns of FIG. 4B

| | IMPRESSION |
|---|---|
| Targeting area (criterion) | FORECAST |
| DFW embarkation (alone) | 1 mm |
| ORD arrival (alone) | 0.75 mm |
| DFW embarkation and ORD arrival | 0.25 mm |

In one aspect consistent with certain principles related to the present invention, publisher 120 may generate an inventory map forecast based on the macro forecast information for future site visits, historical site visit data and their corresponding PNR element information, and targeting criteria and duration data for active (e.g., DFW) and prospective campaigns (e.g., ORD). Publisher 120 may determine historical site visit proportions for various targeting areas based on the historical site visit data, and multiply the proportions with the macro forecasts to generate the inventory map forecast in accordance with certain principles related to the present invention. An inventory map for n campaigns may contain an impressions breakdown for 2ₙ−1 targeting criterion.

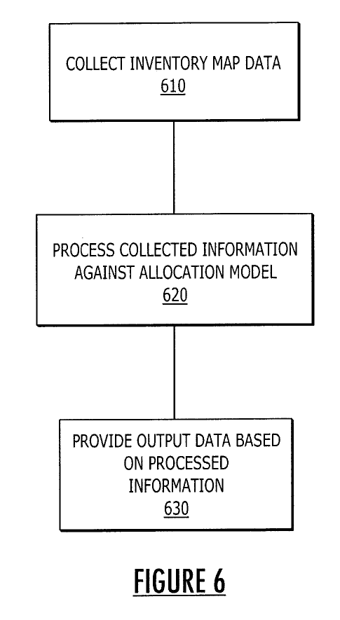

Once the impressions are forecasted for the targeting criteria associated with the campaigns provided by publisher 120, allocation module 123 may determine the allocation of impressions to the campaigns. Impressions that may be targeted to more than one campaign (e.g., the third row in Table 2) may be assigned using an allocation model which may ensure that each impression is assigned to at most one campaign. The model may allocate impressions to new campaign requests after withholding enough impressions for the existing campaigns. This enables publisher 120 to ensure that a contracted campaign, such as the exemplary DFW campaign, will receive enough impressions to meet a contracted number of impressions. FIG. 6 shows a flowchart of an exemplary impression allocation process consistent with certain features related to the present invention.

As shown, allocation module 123 may collect inventory map information that includes the supply forecasts for each targeting criterion, the CPM rates and contracted impressions for existing campaigns, and the CPM rates and demanded (requested) impressions for prospective campaigns (Step 610). This information may be processed against an allocation model to ensure certain conditions are maintained (Step 620). For example, the model may ensure that allocations for existing campaigns should equal contracted impressions, the allocations for prospective campaigns do not exceed their demand, and the total allocations for each targeting criterion do not exceed their supply forecasts. Further, the model may consider the recapture of spilled demand from one ad position to another. A demand spill may reflect a deficit between a total number of allocated impressions and requested impressions for a campaign. The recapture of spilled demand may be performed by allocation module 123 and may include deflecting impression allocations to one or more other campaigns based on certain characteristics, such as CPM values.

Once processed, allocation module may provide ad revenue information, identification of campaigns that may miss their impression goals (i.e., lagging campaigns), and allocations for the prospective campaigns (Step 630).

To further explain the impression allocation features consistent with certain principles related to the present invention, consider a request for a third campaign targeting travelers on a particular airline, such as Delta. Table 3 shows the CPM rates and demanded impressions for the prospective campaigns, (i.e., the new campaign requests including the ORD and Delta travelers campaigns).

TABLE 3
CPM rates and demand data for two prospective campaigns

| Campaign | CPM | Demand (impressions) |
|---|---|---|
| ORD arrivals | $30 | 1 mm |
| Delta travelers | $35 | 1.2 mm |

Assuming that publisher 120 contracted with provider 110 to provide 1.1 mm impressions for the DFW campaign and that all campaigns have the same duration, publisher 120 may generate the inventory map forecast shown in Table 4.

TABLE 4
Forecasted supply for the DFW, ORD, and Delta campaigns

| | IMPRESSION |
|---|---|
| Targeting Criteria | FORECAST |
| DFW embarkation (alone) | 750 k |
| ORD arrival (alone) | 650 k |
| Travel on DL (alone) | 1000 k |
| DFW embarkation and ORD arrival | 150 k |
| (Travel on non-DL) | |
| DFW embarkation and Travel on DL | 250 k |
| (not arriving in ORD) | |
| ORD arrival and Travel on DL | 100 k |
| (not embarking in DFW) | |
| DFW embarkation, ORD arrival, and | 100 k |
| Travel on DL | |

In accordance with one aspect consistent with the present invention, publisher 120 may maximize revenue by allocating impressions to the two prospective campaigns after allocating sufficient impressions to the DFW campaign. Further, the forecasted impressions for each targeting criterion may be additional constraints on the allocation model that is used by publisher 120 and allocation module 123. According to the allocation model implemented by publisher 120, for any targeting criterion, the total allocated impressions should not exceed the forecasted supply of impressions. Table 5 shows an exemplary impression allocation for each targeting criterion in accordance with one aspect consistent with the present invention.

TABLE 5
Allocation of available impressions to three campaigns

| | | | ALLOCATIONS | | |
|---|---|---|---|---|---|
| | | IMPRESSION | DFW | ORD | DL |
| | Targeting Criteria | FORECAST | CAMPAIGN | CAMPAIGN | CAMPAIGN |
| 1 | DFW embarkation (alone) | 750k | 750k | — | — |
| 2 | ORD arrival (alone) | 650k | — | 650k | — |
| 3 | Travel on DL (alone) | 1000k | — | — | 1000k |
| 4 | DFW embarkation and ORD arrival | 150k | 133k | 17k | — |
| | (Travel on non-DL) | | | | |
| 5 | DFW embarkation and Travel on DL | 250k | 161k | — | 89k |
| | (not arriving in ORD) | | | | |
| 6 | ORD arrival and Travel on DL | 100k | — | 25k | 75k |
| | (not embarking in DFW) | | | | |
| 7 | DFW embarkation, ORD arrival, and | 100k | 56k | 8k | 36k |
| | Travel on DL | | | | |
| | Total allocated impressions | | 1.1 mm | 0.7 mm | 1.2 mm |
| | Total requested impressions | | 1.1 mm | 1.0 mm | 1.2 mm |

For the first three targeting criteria, allocation module 123 may allocate the forecasted impressions to each of the respective campaigns. The fourth targeting criterion may have its impression supply allocated to either the DFW and/or ORD campaigns. As shown in Table 5, out of 150K impressions, 133K are allocated to the DFW campaign and 17K are allocated to the ORD campaign. Further, the 250K forecasted impressions for the fifth targeting criterion are allocated between the DFW and DL campaigns, while the 100K forecasted impressions for the sixth criterion are dispersed between the ORD and DL campaigns. The last targeting criterion may have its 100K forecasted impressions allocated to any of the three campaigns.

The total allocation for the DFW campaign is 1.1 mm impressions as required (contracted) and the total allocated impressions for DL campaign is 1.2 mm as requested. The total allocation for ORD campaign, however is 700K, where the requested impressions was 1 mm. To compensate for the allocation deficit, publisher 120 may allow overlapping inventory to be resolved in favor of the DL and DFW campaigns to maximize revenue. That is, because the DL campaign has a CPM of $35 as opposed to $30 CPM for ORD campaign, available impressions may be directed to either the DL or DFW campaign to allow publisher to maximize its revenue generated from providing the three campaigns. The exemplary allocations shown in Table 4 will result in maximum revenue for publisher 120 because any other allocation-combinations may result in either the same or lower revenue. One skilled in the art would appreciate that the information depicted in Table 4 are not intended to be limiting and are presented for exemplary reasons. Publisher 120 may provide a number of different campaigns and determine various impressions forecasts for these campaigns based on principles related to the present invention.

The exemplary impression forecast shown in Table 4 describes the allocation of impressions when prospective campaign requests are received by publisher 120. In one aspect consistent with certain features related to the present invention, the allocations may be recomputed when the impression supply forecasts shrink. This enables publisher 120 to identify existing campaigns that are likely to miss their impression goals. Identifying these campaigns may allow publisher 120 to take corrective actions, such as relaxing the targeting criterion of the lagging or extending the duration for the campaign or targeting criterion.

In one aspect consistent with certain features related to the present invention, the allocation module 123 may automatically recapture spilled demand from one ad position to another. Alternatively, the recapture process may be performed manually. The allocation module 123 may perform a recapture process to maximize the revenue for publisher 120. For example, as shown in Table 5, the spill for the ORD campaign is 0.3 mm (1 mm-0.7 mm). Publisher 120 may allocate impressions in other comparable ad positions to satisfy this spilled demand. It should be noted, however, that provider 110 may not be willing to accept a 100% recapture of the spilled demand to another ad position. Accordingly, depending on the attractiveness of a suggested alternative ad position (i.e., certain ad positions may have better marketing potential), the recaptured demand may vary from 0-100% of the spilled demand.

Having described the general processes associated with supply forecasting and impression allocation in accordance with certain features related to the present invention, the processing of a sales cycle, such as the reserving, booking, and delivery of impressions is described below.

There may be multiple stages associated with a sales cycle. First, publisher 120 may contact an advertiser, such as provider 110. Second, publisher 120 and provider 110 may collectively determine and finalize targeting criterion for a campaign. Third, publisher 120 may determine available impressions. Fourth, publisher 120 may prepare and send an order for providing one or more campaigns to provider 110. And last, publisher 120 may receive a signed order from provider 110. The second stage and third stages may be iterative. In each iteration, supply forecasting and impression allocations may be done to determine the number of impressions available given the determined targeting criterion. In the fourth stage, a campaign order containing the final targeting criterion, duration, and CPM may be prepared. The order may be sent to provider 110 for confirmation. Provider 110 may confirm the order by returning a signed copy of the order in the fifth stage.

Generally, there may be lead-time between the fourth and fifth stages. During this time period, a campaign may be designated as a reserved campaign. Once the order is confirmed (after stage 5) it becomes a booked campaign. In one aspect consistent with certain features related to the present invention, if a reserved campaign is not confirmed in a predetermined period of time, such as one week, the order may be cancelled by publisher 120. Accordingly, publisher 120 may consider booked campaigns when determining allocations for prospective campaigns. Allocated impressions for a prospective campaign may decrease if its reservation is not confirmed promptly. The decrease in allocation impressions may occur because other reserved campaigns in a sales pipeline may confirm during the delay. When an order is confirmed, publisher 120 may perform the supply forecasting and impression allocation processes again to determine available impressions for the confirmed prospective at the time of the confirmation.

Once a campaign is booked, it may be loaded onto ad server 130 by publisher 120. Alternatively, ad server 130 may request and receive a booked campaign periodically or on demand. For example, ad server 130 may send a request to publisher 120 to determine whether there are any booked campaigns that are ready for processing (e.g., delivering impressions on selected web page locations). Publisher 120 may respond to the request by providing the booked campaigns or providing a message indicating the presence of booked campaigns to ad server 130. If a message is received, ad server 130 may retrieve the booked campaigns for processing. Additionally, publisher 120 may also load the campaign's targeting criterion, duration, and impression goals onto ad server 130. The impression goals may be provided to the ad server 130 based on targeting criteria. For example, Table 6 shows a listing of exemplary impression goals that may be communicated to ad server 130. Each combination of targeting criterion, duration, and an impression goal may be modeled as a flight for ad server 130. Accordingly, the three exemplary campaigns shown in Table 6 may each include four flights.

TABLE 6
Exemplary Impression Goals for the DFW, ORD, and DL Campaigns

| | | | Impression |
|---|---|---|---|
| Campaign | Targeting Criterion | Duration | Goal |
| DFW | DFW embarkation, no ORD | 11/1-11/30 | 750 k |
| campaign | arrival and no travel on DL | | |
| | DFW embarkation, ORD | 11/1-11/30 | 133 k |
| | arrivals and no travel on DL | | |
| | DFW embarkation, travel on DL | 11/1-11/30 | 161 k |
| | and no arrival in ORD | | |
| | DFW embarkation, ORD arrival | 11/1-11/30 | 56 k |
| | and travel on DL | | |
| | Aggregate impression goal for | 11/1-11/30 | 1,100 k |
| | DFW campaign | | |
| ORD | ORD arrival, no DFW | 11/1-11/30 | 650 k |
| campaign | embarkation and no travel | | |
| | on DL | | |
| | DFW embarkation, ORD arrival, | 11/1-11/30 | 17 k |
| | and no travel on DL | | |
| | ORD arrival, travel on DL and | 11/1-11/30 | 25 k |
| | no DFW embarkation | | |
| | DFW embarkation, ORD arrival, | 11/1-11/30 | 8 k |
| | and travel on DL | | |
| | Aggregate impression goal for | 11/1-11/30 | 700 k |
| | ORD campaign | | |
| DL | Travel on DL, no DFW | 11/1-11/30 | 1,000 k |
| campaign | embarkation, no ORD arrival | | |
| | Travel on DL, DFW | 11/1-11/30 | 89 k |
| | embarkation, and no ORD | | |
| | arrival | | |
| | Travel on DL, ORD arrival and | 11/1-11/30 | 75 k |
| | no DFW embarkation | | |
| | DFW embarkation, ORD arrival, | 11/1-11/30 | 36 k |
| | and travel on DL | | |
| | Aggregate impression goal for | 11/1-11/30 | 1,200 k |
| | DL campaign | | |

In one aspect consistent with the present invention, when aggregate impression goals are delivered to ad server 130, metering processes performed by the ad server 130 may deliver impressions according to the allocations determined by publisher 120, such as the allocations depicted in Table 5. Given an aggregated impression goal for a campaign, ad server 130 may attempt to deliver content (e.g., advertisements) at a constant rate over a scheduled duration of the campaign while varying the content served for each site visit.

In one aspect consistent with certain features related to the present invention, ad server 130 may determine a priority value associated with a campaign priority on the campaign's remaining duration and impression goal. Alternatively, publisher 120, either through metering module 128 or some other module or process, may determine a priority value associated with each campaign. The priority value may be determined as a ratio of a percentage amount of time remaining in the duration of a campaign to a percentage amount of the number of un-served impressions. If the ratio is less than 1, the campaign may be determined as behind schedule and ad server 130 may accelerates the delivery of impressions for the campaign by giving the campaign a higher priority value. Alternatively, if the ratio is greater than 1, the campaign may be ahead of the schedule and ad server 130 may slow down the delivery of impressions for the campaign by giving the campaign a lower priority value.

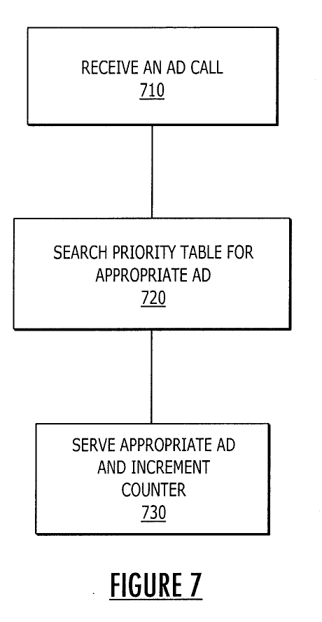

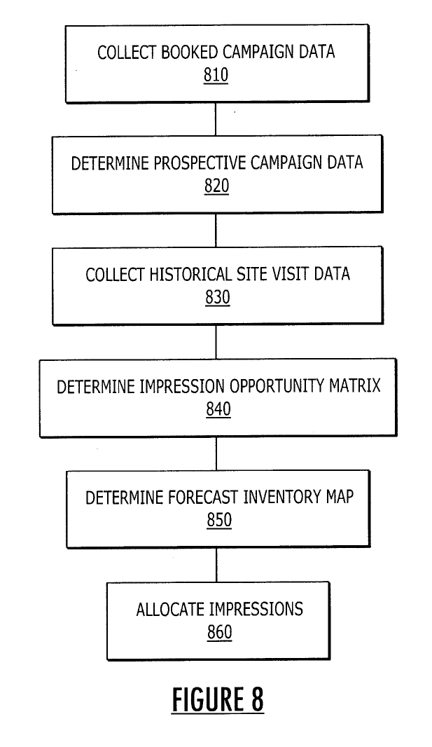

In one aspect consistent with certain features related to the present invention, ad server 130 (or publisher 120) may periodically generate priority tables, such as every 30 seconds. A priority table may be a table, queue, or similar storage configuration, that stores priority values for each campaign that is to be delivered by ad server 130. FIG. 7 shows a flowchart of an exemplary ad server delivery process consistent with certain principles related to the present invention.

As shown, ad server 130 may receive an ad call, which is a communication identifying the condition that an ad position is available for a site visit based on the user and web site and/or page visited by the user (Step 710). Based on the ad call, ad server 130 may access the priority table and search, starting at the top of the table and moving down, for an advertisement with targeting criterion that satisfies the conditions of the ad call (Step 720). For example, a user whose PNR indicates that they are embarking from Dallas Fort Worth (ECY=DFW) may satisfy the targeting criterion for the DFW campaign. Accordingly, any advertisements associated with the DFW campaign may be selected as content to be served in the available ad position. If there is more than one campaign that can be selected to serve the content, campaign priorities can be used to break the ties. Accordingly, ad server 130 may select an ad whose targeting criterion satisfies the conditions of the ad call and has the lowest ad counter value (or highest priority value) relative to its remaining impression goal and duration.

Once ad server 130 selects and serves the appropriate ad to the available ad position, it may increment an ad counter. Each ad counter value may be used to calculate a priority value for the campaign (Step 730). Ad server 130 may be configured to prevent the delivery of consecutively ads that are alike when a subsequent ad call is received by ad server 130. For example, ad server may implement temporary ad counters that track the number of impressions served in last 30 seconds. When more than one campaign may be selected to serve the content (e.g., an appropriate ad), a campaign with the least number of impressions in last 30 seconds may be selected based on a corresponding ad counter value.

Although the process shown in FIG. 7 is described as being performed by ad server 130, one skilled in the art would appreciate that this process may be performed by another entity, such as publisher 120, without departing from the scope of the invention. In this aspect of the invention, publisher 120 may determine and adjust priority values associated with each campaign and provide this information to ad server 130 for delivery of the impressions corresponding to the campaigns according to their priorities.

In one aspect consistent with certain features related to the present invention, publisher 120 may make adjustments to the delivery of impressions for each campaign based on the priority values indicated in the priority tables, or through feedback data that may be monitored by performance monitoring module 129. For example, suppose publisher 120 is running an ad campaign whereby 100 impressions of an advertisement should be delivered every hour for thirty days. During the ad campaign, performance monitoring module 129 may detect slow periods of impression deliveries, such as from midnight to 8:00 AM. For instance, because there may be a reduction in site visits from midnight to 8:00 AM—less people are on-line during this time frame—the number of impressions that may be delivered is reduced (e.g., from 100 impressions to 50 impressions an hour during that time period). Accordingly, the impression goal for a 24 hour period may be 400 ads short (e.g., 2000 ads delivered instead of 2400 ads). To compensate for the lag in impression deliveries, publisher 120 may adjust the average delivery rate to allow the total impression allocation goal to be obtained. Therefore, in the above example, instead of 100 ads per hour being delivered daily, publisher 120 may raise the delivery rate to 117 ads per hour to attempt to compensate for the shortfall of impressions on the following day. This hourly scheduling of impression goals may be calculated by modeling the appropriate time granularity in the present invention.

As described, methods, systems, and articles of manufacture consistent with certain features related to the present invention, allow publisher 120 to forecast a supply of impressions and allocate the impressions among several campaigns. To understand the details creating and delivering campaigns, FIG. 8 shows a flowchart of an exemplary impression allocation process consistent with certain aspects related to the present invention.

As shown, the process may begin with publisher 120 collecting booked (active and pending) campaign data from ad sever 130, such as targeting criterion, CPM, duration, and impression goals (Step 810). The impression goal for an active campaign may be determined as the original impression goal (at the start of the campaign) minus the impressions served by ad server 130. Also, publisher 120 may determine the prospective campaign data, such as targeting criterion, CPM, and duration information (Step 820). The prospective campaign data may be collected during or after negotiations with provider 110. Further, publisher 120 may collect historical site visit data from database that logs this information (not shown) (Step 830). The historical site visit data may include hourly, daily, weekly, monthly, etc., site visit history data and site visit parameter information (e.g., targeting elements) associated with each logged visit.

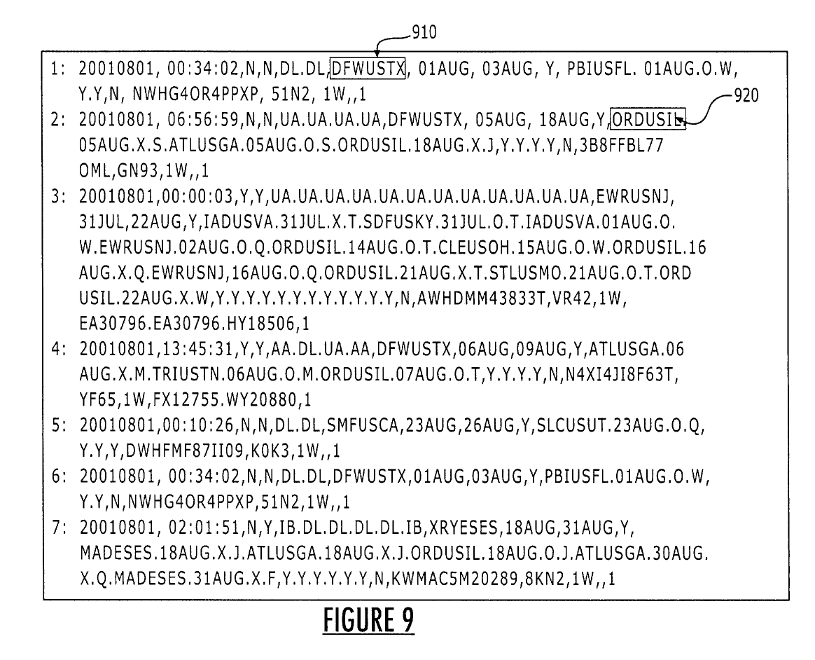

Based on the targeting criterion and the historical visit data, publisher 130 may determine an impression opportunity matrix. This matrix may include a number of columns that correspond to the number of campaigns (booked and prospective) and a number of rows that correspond to the number of historical site visits (provided by the historical site visit data). In one aspect consistent with certain features related to the present invention, an entry in the matrix is equal to “1” if the visit parameters of the corresponding row (e.g., historical site visit) satisfy the targeting criterion of the column (e.g., campaign). Otherwise the entry is equal to “0”. To create the matrix, publisher may run a software script, such as a script programmed from the Awk programming language. The software script (e.g., awk script) may be configured by publisher 130 to search a log file of site visits for a target time period. For example, FIG. 9 is a non-limiting example of a log file that includes ad tags (visit parameters) corresponding to a particular month, such as August 2001. Each line of the log file corresponds to a site visit. The values for each ad tag field is separated by a comma (“,”) and Table 7 shows a description of each field.

TABLE 7
A description of ad tag fields

| Field # | Description |
|---|---|
| 1 | Site visit date (yyyymmdd) |
| 2 | Site visit time (hh:mm:ss in 24 hours format) |
| 3 | Hotel booking present? (Y—yes, N—no) |
| 4 | Car booking present? (Y—yes, N—no) |
| 5 | Airline code (two letter code repeats for each flight leg, |
| | separated by a dot) |
| 6 | Embarkation city (airport code, country code, and state code) |
| 7 | Embarkation date (ddmmm) |
| 8 | Last arrival date (ddmmm) |
| 9 | Overnight stay? (Y—yes, N—no) - is true if any of the |
| | intermediate destinations involve overnight stay |
| 10 | Arrival city (airport code, country code, and state code); arrival |
| | date (ddmmm); connection (X)/overnight stay (O); and arrival |
| | day-of-week. Above values are separated by dots. The values |
| | repeat for each segment |
| 11 | Class of service (F—first, B—Business, C—Coach). Repeats |
| | for each flight leg separated by dots |
| 12 | Gender (Y—Female, N—Male) |
| 13 | Randomly scrambled PNR locator + Lastname |
| 14 | Pseudo city code |
| 15 | Prime host |
| 16 | Hotel property code |
| 17 | Number of passengers on the PNR |

To illustrate how an impression opportunity matrix may be created, consider the three campaigns shown in Table 8. These campaigns are similar to the three campaigns C1-C3 previously described.

TABLE 8
Three exemplary campaigns with corresponding targeting criteria

| Campaign | Desired targeting Criteria |
|---|---|
| C1 | DFW embarkation |
| C2 | ORD arrivals |
| C3 | Travel on DL |

Although Table 8 shows a single targeting criterion for each campaign, one skilled in the art would realize that campaigns may require compound targeting, such as travelers embarking from DFW and staying overnight in LAX.

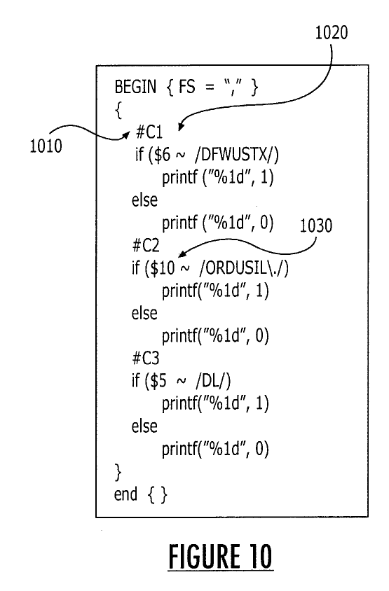

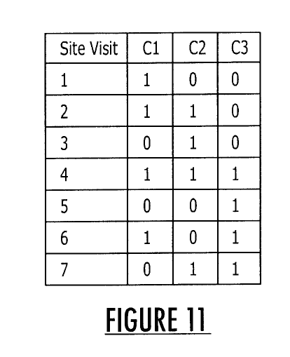

Based on the three exemplary campaigns C1, C2, and C3, publisher 120 may configure and run an awk script to generate the opportunity matrix. FIG. 10 is a non-limiting example of an awk script that may be configured and executed for creating an impression opportunity matrix for campaigns C1, C2, and C3. Running the awk script illustrated in FIG. 10 on the exemplary ad tags records shown in FIG. 9 may create the impression opportunity matrix depicted in FIG. 11.

The awk script shown in FIG. 10 includes sub-scripts associated with each campaign. For instance, campaign C1 included in the exemplary campaigns shown in Table 8 is designated by element 1010. Because campaign C1 includes targeting criterion associated with DFW embarkations (see Table 8), the programming statements for campaign C1 in the awk script may include instructions to search for an embarkation code identifying DFW in the log file shown in FIG. 9. Because field six (6) of the log file is dedicated to embarkation city codes (see Table 7, Field 6), the awk script may be configured to search field six of every site visit record in the log file, as indicated by element 1020 in FIG. 10. Note that the embarkation city code defined in Table 7 includes an airport code, a country code, and a state code. Accordingly, the awk script is configured to search for a code that satisfies this field definition, such as “DFWUSTX.” If a site visit record matches the embarkation code in field six, a “1” is created for that record (row) in column 1 of the impression opportunity matrix. For example, as shown in FIG. 9, field six of the first site visit record, identified by element 910, matches the embarkation code targeted by campaign C1. Accordingly, the awk script generates a “1” in the first column of row 1 of the opportunity matrix, as shown in FIG. 11. Further, because field ten (10) of campaign C2 does not match the arrival city code designated in the awk script (see element 1030 in FIG. 10), a “0” is generated in the second column of the first row in the matrix, as shown in FIG. 11. Field 10 of the second site visit record, however, matches the awk script condition (see element 920 of FIG. 9 and element 1030 of FIG. 10). Accordingly, the awk script may generate a “1” for the second column of the second row of the matrix, as shown in FIG. 11.

As can be seen, record 1 of the log file shown in FIG. 9 has an opportunity to show impressions for campaign C1, but none for other two campaigns C2 and C3. On the other hand, the second record has an opportunity for showing impressions for both campaigns C1 and C2, which results in a potential ad collision condition. Thus, the impression opportunity matrix shown in FIG. 11 may indicate potential ad collisions based on the presence of multiple “1s” in a row. Additionally, impression opportunities for other ad tags records may be interpreted by publisher 130. When the awk script is executed on all logs records of a log file, such as 4.375 mm records, the result may be an impression opportunity matrix with three columns and 4.375 mm rows.

Returning to FIG. 8, once the impression opportunity matrix is generated, it may be provided to supply forecasting module 122. This module collects the matrix, along with targeting criteria and duration data for the campaigns and the macro forecasts previously determined by publisher 130, and creates a forecast inventory map (Step 850).

When there are three campaigns, seven disjoint targeting criteria are possible as shown in the first column of Table 4. Referring to the first targeting criteria, DFW embarkation (alone), if a logged site visit falls into this target area, it will result in publisher 130 generating a row value of “100” in the impression matrix. Table 9 shows the row values for each of the seven exemplary disjoint targeting criteria described in Table 4.

TABLE 9
Row outputs for the seven disjoint targeting criteria

| | ROW |
|---|---|
| Targeting area | OUTPUT |
| DFW embarkation (alone) | 100 |
| ORD arrival (alone) | 010 |
| Travel on DL (alone) | 001 |
| DFW embarkation and ORD arrival (Travel on non-DL) | 110 |
| DFW embarkation and Travel on DL (not arriving in ORD) | 101 |
| ORD arrival and Travel on DL (not embarking in DFW) | 011 |
| DFW embarkation, ORD arrival, and Travel on DL | 111 |

The number of rows of each output type is counted by publisher 120 to determine the historical impression opportunities for each targeting criterion. Publisher 120 may count each output type using a variety of techniques, including executing program code using one or more processors. For example, the following exemplary C++ source code may be used for counting the historical impression opportunities in accordance with certain principles related to the present invention:

while(is >> Target)
{

++Counts[Target]; // Target is created automatically if
it hasn't been seen yet
++nSiteVisits;

}

In one aspect consistent with certain features of the present invention, all multi-way collisions occurring in the input data may be calculated in O(m min(n, log m)) time, where m is the number of historical site visits and n is the number of campaigns. For each row in the impression opportunity matrix, a string consisting of 0s and 1s may be read in, and a search is performed in counts (which may be declared as aStandard Template Library (STL) map), until a counter for this target is found. If a counter is not found, a new target may be created. The search takes at most O(min(n, log m)) steps because there can be at most min(m, 2ⁿ) unique targets. Once the search is completed, the counter may be incremented by one.

For example, Table 10 shows the results of a counting process associated with impression opportunities by targeting criterion for the population of 4.375 million logs. The third column contains impression opportunities for each targeting criterion as a percent of total impression opportunities (i.e., 4.375 mm).

TABLE 10
Row outputs for the seven disjoint targeting criteria

| | | PROPORTION OF |
|---|---|---|
| | IMPRESSION | IMPRESSION |
| Targeting area | OPPORTUNITIES | OPPORTUNITIES |
| DFW embarkation (alone) | 656250 | 0.15 |
| ORD arrival (alone) | 568750 | 0.13 |
| Travel on DL (alone) | 875000 | 0.2 |
| DFW embarkation and ORD | 131250 | 0.03 |
| arrival | | |
| (Travel on non-DL) | | |
| DFW embarkation and Travel | 218750 | 0.05 |
| on DL | | |
| (not arriving in ORD) | | |
| ORD arrival and Travel | 87500 | 0.02 |
| on DL | | |
| (not embarking in DFW) | | |
| DFW embarkation, ORD | 87500 | 0.02 |
| arrival, and Travel | | |
| on DL | | |

For exemplary purposes, assume that all three campaigns are requested to run from Nov. 1, 2002 thru Nov. 30, 2002 (as shown in Table 6). Further assume that the macro forecast for site visits during November 2002 is 4,761,905. As previously described, 84% of site visits historically result in successful retrieval of PNR elements (ad tags). This amounts to 4 mm (0.84×4,761,905) targetable site visits (PNR okays) during November 2002. Publisher 120 may determine the impression forecast for a targeting criterion by multiplying the forecasted PNR okays with the corresponding historical proportion. For example, for the first targeting criterion the forecast is:

4,000,000 (macro forecast)×0.15 (percent impression opportunities)×1.25 (page visit to impression conversion factor)=750,000 impressions

Table 4 shows the inventory map (supply) forecast by targeting criterion during November 2002 in accordance with the exemplary data discussed above.

Once the inventory map is determined, publisher 120 may allocate the impressions (Step 860). To do so, the inventory map forecast, CPM rates, and contracted allocations for booked campaigns, as well as the demanded impressions and CPM rates for the prospective campaigns, are provided to the allocation module 123. This module may allocate impressions for the various campaigns in such a manner as to maximize revenue for publisher 120 and provide indications of lagging campaigns. The lagging indications may be used by publisher 120 and ad server 130 to prevent allocation goals from being missed by scheduling make-goods, or by serving impressions in other ad positions

As previously mentioned, and as an example, 1.1 mm impressions may have been contracted to the DFW campaign at a CPM of $28. The demand for the ORD and Delta campaigns (prospective campaigns) may be 1 mm and 1.2 mm impressions, respectively, and their CPMs may be $30 and $35, respectively. In one aspect consistent with certain features related to the present invention, publisher 130, and/or allocation module 123 may attempt to maximize revenue by allocating an available supply of impressions to the prospective campaigns. Further, sufficient impressions are allocated to DFW campaign to honor the existing contract of 1.1 mm impressions.

In one aspect consistent with certain principles related to the present invention, publisher 120 and allocation module 123 may perform the maximization functions based on an allocation model that may be reflected as a linear programming model. For example, publisher 120 may let xᵢⱼ denote the number of impressions allocated to i^{th} campaign from targeting criterions j. According to these definitions, the allocation of impressions to maximize revenue based on the exemplary campaigns and targeting criteria previously described may be stated as the following linear programming model.

Maximize 0.03(x₂₂+x₂₄+x₂₆+x₂₇)+0.035(x₃₃+x₃₅+x₃₆+x₃₇):ad revenue from new campaign Subject to the following constraints:

x₁₁+x₁₄+x₁₅+x₁₇=1,100,000: total allocation for the DFW campaign equals contracted amount

x₂₂+x₂₄+x₂₆+x₂₇≦1,000,000: total allocation for ORD campaign cannot exceed its demand

x₃₃+x₃₅+x₃₆+x₃₇≦1,200,000: total allocation for DL campaign cannot exceed its demand

x₁₁≦750,000: total allocation from area 1 cannot exceed its supply

x₂₂≦650,000: total allocation from area 2 cannot exceed its supply

x₃₃≦1,000,000: total allocation from area 3 cannot exceed its supply

x₁₄+x₂₄≦150,000: total allocation from area 4 cannot exceed its supply

x₁₅+x₃₅≦250,000: total allocation from area 5 cannot exceed its supply

x₂₆+x₃₆≦100,000: total allocation from area 6 cannot exceed its supply

x₁₇+x₂₇+x₃₇≦100,000: total allocation from area 1 cannot exceed its supply

x₁₁,x₁₄,x₁₅,x₁₇,x₂₂,x₂₄,x₂₆,x₂₇,x₃₃,x₃₅,x₃₆,x₃₇≧0: allocations are non-negative

The function maximizes the total ad revenue from the new campaigns ORD and Delta. The function 0.03(x₂₂+x₂₄+x₂₆+x₂₇) corresponds to campaign C2 (ORD campaign) that has a CPM of $30, while the function 0.035(x₃₃+x₃₅+x₃₆+x₃₇) corresponds to campaign C3 (Delta campaign) that has a CPM of $35. The first constraint guarantees delivery of the contracted impressions to the DFW (existing) campaign. The second and third constraints ensure that the total allocation for each of the new campaigns does not exceed the corresponding demand. Constraints 4 through 10 ensure that total allocation from each targeting area does not exceed the corresponding supply. The last constraint is a non-negativity constraint on allocations. Allocation module 123 may solve the above exemplary linear programming model to generate the exemplary allocations shown in Table 5.

As described, methods, systems, and articles of manufacture consistent with certain features related to the present invention allow publisher 120 to perform supply forecasting and allocation processes when all the campaigns have identical durations. In accordance with another aspect consistent with certain features related to the present invention, publisher 120 may also perform supply forecasting and allocation processes when different campaigns have different durations.

To illustrate this aspect of the invention, consider the exemplary campaigns described in Table 12. As shown, the 1.1 mm impressions contracted to the DFW campaign are to be delivered from November 1 thru November 15. Further, the two exemplary prospective campaigns, ORD arrivals and DL travelers. The ORD campaign requested 1 mm impressions at $30 CPM to be delivered between November 5 and November 30. The DL campaign requested 1.2 mm impressions at $35 CPM to be delivered between November 5 and November 20.

TABLE 12
Active and prospective campaigns along with their duration,
impression contracts/demands, and CPMs

| | | Active/ | Contracted/ | |
|---|---|---|---|---|
| | | Pro- | Demanded | |
| Campaign | Duration | spective | Impressions | CPM |
| DFW embarkation | 11/1 to 11/15 | Active | 1.1 mm | $28 |
| ORD arrivals | 11/5 to 12/5 | Prospective | 1 mm | $30 |
| DL travelers | 11/5 to 11/20 | Prospective | 1.2 mm | $35 |

The earliest start date for all of the campaigns is the first of November (November 1). The DFW campaign starts on this date. From November 1 thru November 4, only the DFW campaign is active, thus no ad collisions with other campaigns will occur. Because, however, between November 5 and November 15 all three campaigns are active, up to 3-way collisions may occur. Further, between November 16 and November 20, the ORD and DL campaigns are active, which may result in possible 2-way ad collisions. Finally, between November 21 and December 5, only the ORD campaign is active, thus no ad collisions may occur.

As shown in Table 12, the campaign combinations may change across the total period of interest including November 1 thru December 5. Table 13 summarizes this break down of total period of interest that spans from the earliest begin date (November 1 for DFW campaign) thru the latest end date (December 5 for ORD campaign).

TABLE 13
Duration and macro forecasts for the sub-periods

| Sub- | | Macro forecast | Macro forecasts |
|---|---|---|---|
| period | Duration | for site visits | for PNR okays |
| 1 | 11/1-11/4 | 493,971 | 414,936 |
| 2 | 11/5-11/15 | 2,206,554 | 1,853,506 |
| 3 | 11/16-11/20 | 890,781 | 748,256 |
| 4 | 11/21-12/5 | 2,162,015 | 1,816,093 |

In one aspect consistent with certain features related to the present invention, publisher 120 may break down the period of interest into sub-periods such that each sub-period starts either on begin date of a campaign, or on a day after end date of a campaign and each sub-period ends either on end date of a campaign, or on a day prior to begin date of a campaign. The above exemplary break down is the minimum cardinality set of sub-periods satisfying the property that no campaign either begins or ends during the middle of a sub-period.

Table 13 also contains the macro forecasts for site visits during each sub-period. Monthly macro forecasts may be projected onto these sub periods, using day-of-week seasonalities. Table 14 shows exemplary weekly seasonalities that may be obtained from historical site visits.

TABLE 14
Day-of-week seasonalities for site visits

| Day of week | Seasonality |
|---|---|
| Monday | 1.428091 |
| Tuesday | 1.365435 |
| Wednesday | 1.295673 |
| Thursday | 1.290572 |
| Friday | 1.184212 |
| Saturday | 0.201712 |
| Sunday | 0.234304 |

The day-of-week seasonalities may be obtained by determining average site visits for each day of week based on historical site visit data collected by publisher 120. For example, publisher 120 may allow the variables aₘₒₙ, aₜᵤₑ, a_{wed}, aₜₕᵤ, a_{fri}, aₛₐₜ, and aₛᵤₙ correspond to average site visits during Monday, Tuesday, Wednesday, Thursday, Friday, Saturday, and Sunday, respectively. Further, publisher 120 may allow a to be the average of all day-of-week averages. Consequently, publisher 120 may determine the seasonality for Monday by determining the ratio of aₘₒₙ to a. Similarly, the seasonalities for other days of week may be computed by publisher 120. The seasonalities shown in Table 14 are exemplary and may be based on a particular month and year, such as January 2002.

Assuming that the macro forecasts for site visits during November 2002 and December 2002 are 4,761,905 and 3,434,908, respectively, publisher 120 may determine the macro forecast for each period. For example, the first sub-period from November 1 to November 4 may consists of a Friday, Saturday, Sunday, and a Monday. This amounts to 3.048319 equivalent days, obtained by adding the seasonalities of Friday, Saturday, Sunday, and Monday from Table 14. In total there are four Thursdays, five Fridays, five Saturdays, four Sundays, four Mondays, four Tuesdays, and four Wednesdays in November 2002. This amounts to 29.38592 equivalent days, obtained by adding five times the seasonalities of Friday and Saturday, and four times the seasonalities of Sunday, Monday, Tuesday, Wednesday, and Thursday. Once this information is determined or obtained by publisher 120, it may determine the macro forecasts for each sub-period based on the following exemplary formula:

$$Macro forecast for target sub period = \frac{( Equivalent days during sub period )}{\begin{matrix}( Equivalent days during month that \\ includes the sub period )\end{matrix}} \times \begin{matrix}( Macro forecast for month that \\ includes the sub period )\end{matrix}$$

For example, based on the above exemplary information, the macro forecast for the first sub period may be determined as:

$$\begin{matrix}Macro forecast during 11 \text{/} 1 to 11 \text{/} 4 = \frac{Equivalent days during 11 \text{/} 1 to 11 \text{/} 4}{Equivalent days during Nov .} \times \\ Macro forecasts for Nov . \\ = \frac{3.048319}{29.385592} \times 4761905 = 493 , 971 site visits .\end{matrix}$$

Similarly, publisher 120 may compute the macro forecasts for the second and third sub-periods. Because the fourth sub-period spans across November and December, the macro forecasts may be computed separately for November 21 thru November 30 and December 1 thru December 5 and summed. The separate calculations may be performed because the macro forecasts may be different for November and December. The last column in Table 13 is the macro forecasts for PNR okays (successful PNR retrievals). As previously described, historically, 84% of site visits result in successful PNR retrievals from a PNR source system. Accordingly, publisher 120 may multiply the macro forecasts by 0.84 to determine the macro forecasts for PNR okays.

To obtain the inventory map forecast for each sub period, publisher 120 may multiply the macro forecasts (shown in Table 13) by the probabilities of various targeting criteria. In one aspect consistent with certain features related to the present invention, the macro forecasts of Table 13 are multiplied by the probabilities (percent of impression opportunities) for the seven different targeting criteria shown in Table 10 (second column). For instance, publisher may use the following formula to determine the supply forecast for each sub period:

Forecasted site visits that can be targeted to target campaign only during the target sub period=Forecasted total site visits during the target sub period×historical proportion of site visits that can be targeted to the target campaign

Using the above formula and the forecasted PNR okays for each sub period (e.g., site visits with successful PNR retrieval), publisher 120 may determine that only 62,240 (414,936×0.15) site visits may be targeted to the DFW campaign. Similarly, 53,941(414,936×0.13) site visits may be targeted to the ORD campaign, 82,987(414,936×0.2) site visits may be targeted to DL campaign, 12,448(414,936×0.03) site visits may be targeted to either the DFW or ORD campaigns, 20,747(414,936×0.05) site visits may be targeted to either the DFW or DL campaigns, 8,299(414,936×0.02) site visits may be targeted to either the DFW or DL campaigns, and 8,299(414,936×0.02) site visits may be targeted to the DFW, ORD, or DL campaigns.

Publisher 120 may determine the supply (impression) forecasts for each sub period by multiplying the determined site visit forecasts by 1.25, which is the site visit to impression conversion factor. Accordingly, publisher 120 may determine the inventory map for the other sub-periods similarly. Table 15 shows a supply forecast that reflects the inventory maps for each of the four sub-periods associated with the exemplary campaigns described in Table 12.

TABLE 15
Supply forecast: inventory map by sub-period

| | Sub-periods | | | |
|---|---|---|---|---|
| | 11/1- | 11/5- | 11/16- | 11/21- |
| Targeting Criterion | 11/4 | 11/15 | 11/20 | 12/5 |
| DFW embarkation (alone) | 77,800 | 347,532 | 140,298 | 340,517 |
| ORD arrival (alone) | 67,426 | 301,194 | 121,591 | 295,115 |
| Travel on DL (alone) | 103,734 | 463,376 | 187,064 | 454,023 |
| DFW embarkation and ORD | 15,560 | 69,506 | 28,059 | 68,103 |
| arrival (Travel on non-DL) | | | | |
| DFW embarkation and Travel | 25,934 | 115,844 | 46,766 | 113,505 |
| on DL (not arriving in ORD) | | | | |
| ORD arrival and Travel on DL | 10,374 | 46,337 | 18,706 | 45,402 |
| (not embarking in DFW) | | | | |
| DFW embarkation, ORD | 10,374 | 46,337 | 18,706 | 45,402 |
| arrival, and Travel on DL | | | | |

Once the supply forecasting process is complete, publisher 120 may provide the inventory maps into an allocation model for determining the appropriate impression allocations based on the supply forecast for each sub period. In one aspect of the invention, the allocation model previously described may be generalized to the situation wherein campaigns have different durations. Accordingly, in one aspect consistent with certain features related to the present invention, publisher 120 may define the following notations:

Xᵢⱼₜ refers to the impressions allocated to an i^{th} campaign from a j^{th} targeting criterion during sub-period t. For example, x₁₄₁ may be the number of impressions allocated to the DFW campaign from targeting criterion 4 during sub-period 1.

Iᵢⱼₜ is equal to 1 if the i^{th} campaign may allocate impressions from the j^{th} targeting criterion during sub-period t. Otherwise, Iᵢⱼₜ may be set equal to 0. For example, I₁₂ₜ, I₁₃ₜ and I₁₆ₜ equal 0 for all t, since impressions from criterions 2, 3, and 6 cannot be target to the DFW campaigns. Similarly, I₁ⱼ₃ and I₁ⱼ₄ equal 0 for all j, since the duration of the DFW campaign does not span sub-periods 3 and 4.

Cₗ denotes the contracted impressions for l^{th} existing campaign and yₗ equal cₗ minus the total allocations for the l^{th} existing campaign. This may represent the shortage of impressions for campaign l. Further, dₖ denotes the demanded impressions for k^{th} prospective campaign, sⱼₜ is the supply forecast for targeting area j during sub-period t, rᵢ is the CPM for campaign i, and M denotes a positive number such that M is greater than rᵢ for all i.

Based on the above notations, publisher 120 may be configured to formulate an impression allocation as the following linear programming problem:

$$Maximize {\sum }_{k} {r}_{k} ( {\sum }_{j} {\sum }_{t} {I}_{ljt} {x}_{ljt} ) - {\sum }_{l} ( M + {r}_{l} ) {y}_{l}$$

subject to the following constraints:

$${\sum }_{j} {\sum }_{t} {I}_{ljt} {x}_{ljt} + {y}_{l} = {c}_{l} , for all l ( existing campaigns )$$

$${\sum }_{j} {\sum }_{t} {I}_{kjt} {x}_{kjt} \leq {d}_{k} , for all k ( prospective campaigns )$$

$${\sum }_{i} {I}_{ijt} {x}_{ijt} \leq {s}_{jt} , for all j ( targeting areas ) and t ( sub \text{-} periods )$$

xᵢⱼₜ, y₁≧0, for all i, j, t, and l

The above function may be used to maximize the ad revenue generated from allocating impressions to prospective campaigns. Further, the function also minimizes loss of revenue due to shortage of impressions for existing campaigns. The first set of constraints ensure that for each of the existing campaigns, the sum of allocations over all targeting criteria and sub-periods, plus any impression shortage, equals the contracted impressions. The second set of constraints ensure that for each of the prospective campaigns, the sum of allocations over all targeting criteria and sub-periods is no more than the demanded impressions. The third set of constraints states that for each targeting area during each sub-period, the sum of allocations over all campaigns is no more than the forecasted supply. The last set of constraint is a non-negativity constraint on the allocation and shortage decision variables. Shortage decision variables are positive when there is not enough supply to meet the contracted impression goals for the existing campaigns. This may happen when the supply forecasts shrink due to extrinsic conditions, such as an unexpected slowdown of travel.

To illustrate the model based on the data included in Tables 12 and 15, let M be 1. Accordingly, the exemplary allocation problem may be:

Maximize 0.03(x₂₂₂+x₂₄₂+x₂₆₂+x₂₇₂+x₂₂₃+x₂₄₃+x₂₆₃+x₂₇₃+x₂₂₄x₂₄₄+x₂₆₄+x274)+0.03(x₃₃₂+x₃₅₂+x₃₆₂+x₃₇₂+x₃₃₃+x₃₅₃+x₃₆₃+x₃₇₃)−1.028y₁ subject to the following constraints:

x₁₁₁+x₁₄₁+x₁₅₁+x₁₇₁+x₁₁₁+x₁₄₂+x₁₅₂+x_{172 +y}₁=1,100,000

x₂₂₂+x₂₄₂+x₂₆₂+x₂₇₂+x₂₂₃+x₂₄₃+x₂₆₃+x_{273 +x}₂₂₄+x₂₄₄+x264+x₂₇₄≦1,000,000

x₃₃₂+x₃₅₂+x₃₆₂+x₃₇₂+x₃₃₃+x₃₅₃+x₃₆₃+x₃₇₃≦1,200,000

x₁₁₁≦71,636; x₁₁₂≦304,673; x₁₁₃≦108,625; x₁₁₄≦351,875

x₂₂₁≦62,085; x₂₂₂≦264,050; x₂₂₃≦94,141; x₂₂₄≦304,958

x₃₃₁≦95,515; x₃₃₂<406,230; x₃₃₃≦144,834; x₃₃₄≦469,166

x₁₄₁+x₂₄₁≦14,328; x₁₄₂+x₂₄₂≦60,935; x₁₄₃+x₂₄₃≦21,725; x₁₄₄+x₂₄₄≦70,375

x₁₅₁+x₃₅₁≦23,879; x₁₅₂+x₃₅₂≦101,558; x₁₅₃+x₃₅₃≦36,209; x₁₅₄+x₃₅₄≦117,291

x₂₆₁+x₃₆₁≦9,551; x₂₆₂+x₃₆₂≦40,623; x₂₆₃+x₃₆₃≦14,484; x₂₆₄+x₃₆₄≦46,916

x₁₇₁+x₂₇₁+x₃₇₁≦9,551; x₁₇₂+x₂₇₂+x₃₇₂≦40,623; x₁₇₃+x₂₇₃+x₃₇₃≦14,484

x₁₇₄+x₂₇₄+x₃₇₄≦46,916

x₁₁₁,x₁₄₁,x₁₅₁,x₁₇₁,x₁₁₁,x₁₄₂,x₁₅₂,x₁₇₂ ≧0

x₂₂₂,x₂₄₂,x₂₆₂,x₂₇₂,x₂₂₃,x₂₄₃,x₂₆₃,x₂₇₃,x₂₂₄,x₂₄₄,x₂₆₄,x₂₇₄≧0

x₃₃₂,x₃₅₂,x₃₆₂,x₃₇₂,x₃₃₃,x₃₅₃,x₃₆₃,x₃₇₃≧0

y₁≧0

As described, methods, systems, and articles of manufacture consistent with certain features related to the present invention allow publisher 120 to provide advertising revenue, impression allocations for campaigns based on targeting criteria and duration, and supply forecasts. The processes described above and show in the figures may be performed automatically or through user-intervention. For example, in one aspect consistent with the present invention, the supply forecasting and allocation modules may be integrated with a spreadsheet application-based front end. In this aspect of the invention, a user may provide the following data using the exemplary interface: Start day and end day of each sub-period (where all sub-periods may consist of consecutive days), macro forecast for each period, CPM rates for campaigns, contracted impressions for existing campaigns, demanded impressions for prospective campaigns, duration for campaigns, and budget restrictions for each campaign (i.e., budget>=contract pricing).

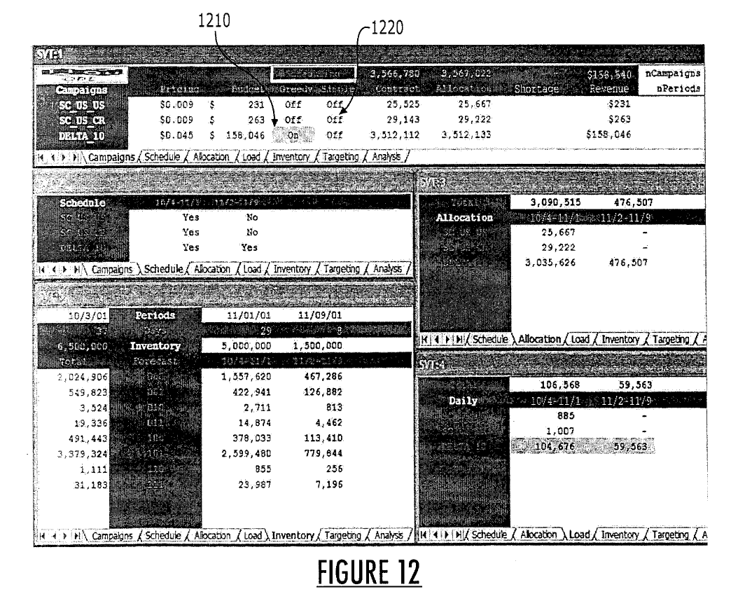

FIG. 12 shows a screen shot of an exemplary user interface in the form of spreadsheets consistent with certain principles related to the present invention. Further, in addition to the above data, a user may request impression allocations in the earliest possible period by setting a ‘Greedy’ option to ‘On’ (see element 1210). Further, the allocation of impressions in the least overlapping target criterion (i.e., with fewest number of competing campaigns) is attempted if a ‘Simple’ option is set to ‘On’ (see element 1220). Also, a user may control the input of information to the exemplary spreadsheets by locking the fields, rendering them inaccessible to unauthorized users.

In the above exemplary aspect of the present invention, the user may be provided as output, campaign revenue, total impression allocation and allocation by sub period for each campaign, undelivered impressions for existing campaigns (if total allocation is less than contracted impressions), and an indication of spilled demand for prospective campaigns (if total allocation is less than demanded impressions). This output information may also be provided in any form through any type of user interface implemented by methods, systems, and articles of manufacture consistent with the present invention.

Publisher 120 may also be configured to receive targeting criterion, duration data, CPM data, and budget information for prospective campaigns automatically. Further, automatic data feeds may be implemented within environment 100 <<105?>> to allow publisher 120 to receive targeting criterion, duration data, CPM data, impression goal data, and impressions served for existing campaigns automatically. Also, the creation of the opportunity matrix, inventory maps, and impression allocations may also be completely automated or performed through user-intervention.

In addition to the automation of the processes described above, methods, systems, and articles of manufacture consistent with certain principles related to the present invention may allow various interfaces to be implemented to present the results of the allocation model, inventory maps, opportunity matrix. For instance, user interfaces may be in the form of software-based displays and hard copy printouts. Further, the output of information may be automatically provided to local and/or remote locations for processing. For example, publisher 120 may be configured to provide the impression allocations to a remote computing system. A user operating the remote computing system may view the output on a display. Alternatively, the remote computing system may be configured to process the allocation output for other purposes, such as marketing analysis.

In addition to impression allocation and forecasting, methods, systems, and articles of manufacture consistent with certain features related to the present invention enable publisher 120 to optimize the revenue generated by running campaigns for providers, including provider 110. For instance, suppose publisher 120 is configured to run two campaigns (C1 and C2) for provider 110 and are based on a hybrid pricing model. That is, for exemplary purposes, publisher 120 may charge provider 110 $50 CPM with an additional $0.50 bonus for each detected click-through for the two campaigns. Further suppose that campaigns C1 and C2 have overlapping targeting criterion such that some site visits may be served with either C1 or C2. For exemplary purposes, suppose there are 1000 visits in the overlap area and campaigns C1 and C2 each have a click rate of 0.5% for these visits. Based on standard delivery revenue models, publisher 120 may server half of the site visits with C1 and the other half with C2. Therefore, the total revenue generated from 1000 visits may be:

$$\begin{matrix}Total Revenue = 500 C1 impressions * \$50 / 1000 impressions + \\ 500 C1 impressions * .0005 Clicks / Impression * \\ \$0 .50 / Click \\ 500 C2 Impressions * \$50 / 1000 impressions + \\ 500 C2 impressions * .0005 Clicks / Impression * \\ \$0 .50 / Click \\ = \$25 + \$1 .25 + \$25 + \$1 .25 \\ = \$52 .50\end{matrix}$$

Accordingly, publisher 120 may generate $52.50, which includes $50 from impressions delivered and $2.50 from 5 clicks based on the click rate for 1000 visits. In one aspect consistent with certain features related to the present invention, publisher 120 may be configured to perform optimization processes that enable publisher 120 to serve a particular ad to an appropriate customer, such as a customer who is more likely to provide a click-through than other customers. Accordingly, publisher 120 may use historical site visit data to collect click-through likelihood information associated with a particular user, type of user, groups of users, and/or combination of groups of users. Alternatively, publisher 120 may obtain profile information associated with a user, group or users, or types of users from a remote source. Accordingly, publisher 120 may identify visitors with higher or lower “likelihood to click” rates for each campaign. For example, Table 16 shows a listing of an exemplary categorization of visitors (V0-V2) based on campaigns C1 and C2.

TABLE 16
Categorization of visitors based on campaigns C1 and C2

| Visit | Click Rate | Click Rate | Number |
|---|---|---|---|
| Category | for C1 | for C2 | of Clicks |
| V0 | 0% | 0% | 800 |
| V1 | 5% | 0% | 100 |
| V2 | 0% | 5% | 100 |

As shown in the table, visitor V0 never clicks, visitor V1 has a high click rate for C1, and visitor V2 has a high click rate for C2. With a click rate of 0.5% for C1 (as previously indicated), 100 of 1000 visits are from visitor V1 and a different 100 must by from V2. Accordingly, 80% of the visits are from V0, 10% from V1, and another 10% from V2. To maximize revenue according to certain features related to the present invention, publisher 120 may determine that visitor V1 should only be served with impressions from campaign C1, while impressions from campaign C2 should only be served to visitor V2. Because visitor V0 does not provide any potential for revenue, even through click-through bonuses, publisher may provide any ad to visitor V0. By performing the above adjustments, publisher 120 may generate the following revenue:

$$\begin{matrix}Total Revenue = 500 C1 impressions * \$50 / 1000 impressions + \\ 100 C1 impressions * .0005 Clicks / Impression * \\ \$0 .50 / Click \\ 500 C2 Impressions * \$50 / 1000 impressions + \\ 100 C2 impressions * .0005 Clicks / Impression * \\ \$0 .50 / Click \\ = \$25 + \$2 .50 + \$25 + \$2 .50 \\ = \$55 .00\end{matrix}$$

According to the above exemplary conditions, publisher 20 may increase revenues by 5% from $52.50 to $55.00 based on an increase in click-throughs (from 5 to 10). One skilled in the art would realize that the optimization features consistent with certain aspects related to the present invention may be applied to a number of different campaigns without departing from the scope of the present invention.

Conclusion

As described, methods, systems, and articles of manufacturer consistent with features of the present invention enable a computing system to forecast web site visits for future periods of time and determine allocations of impressions of content on web pages associated with the web site based on the forecasted site visits and other historical site visit data. Although certain aspects of the present invention were described with respect to web advertisements on a particular type of web site and industry (i.e., travel-based web site and customers), one skilled in the art would realize that the present invention may be associated with any type of content excluding advertisements and travel-based web sites without departing from the scope of the present invention. For example, certain aspects of the present invention may be applied to interactive television environments and similar data delivery systems, such as wireless, open (e.g., NET) and closed (e.g., PSTN) networks.

Additionally, the present invention is not limited to the sequence and configuration of the environments, components, and processes described above. For example, the seasonality factors determined and used by publisher 120 are not limited to general site visits associated with a plurality of individuals. Instead, publisher 120 may determine seasonality factors associated with user-specific trends. For instance, publisher 120 may determine the trends of a particular user based on historical site visit data. That is, a user may have a trend of visiting one or more monitored web sites on weekends only. Accordingly, publisher 120 may create seasonality factors for the user that reflect this trend. Also, the user may have a tendency to visit one or more monitored web sites during a certain time of year (e.g., during selected holidays, etc.), and publisher may determine the corresponding seasonality factors based on these tendencies.

Furthermore, one skilled in the art would appreciate that the above described exemplary codes and names of variables, notations, constraints, etc. associated with these codes are not intended to be limiting. One skilled in the art would realize that any number of programming pseudo-code and syntax may be implemented to perform the functions consistent with certain features and principles related to the present invention.

Additionally, although aspects of the present invention are described as being associated with data stored in memory and other storage mediums, one skilled in the art will appreciate that these aspects can also be stored on or read from other types of computer-readable media, such as secondary storage devices, like hard disks, floppy disks, or CD-ROM, DVD, a carrier wave from the Internet; or other forms of RAM or ROM. Accordingly, the invention is not limited to the above described aspects of the invention, but instead is defined by the appended claims in light of their full scope of equivalents.

What is claimed is:

1. A method for allocating impressions of content in a system including a server configured to manage access to a set of documents, the method comprising:
storing historical data reflecting previous access or attempts to access at least one of the documents;
estimating future traffic for a document included in the set of documents using the stored historical data and seasonality characteristics associated with the previous access or attempts to access the at least one of the documents;
determining whether content associated with a targeting criterion may be allocated to a content delivery campaign;
allocating impressions of the content to the campaign based on the determination and the estimated future traffic; and
delivering the content for the campaign in accordance with the impression allocations.

2. The method of claim 1, wherein allocating impressions further comprises:
distributing impressions of the content to a set of content delivery campaigns based on the determination and the estimated future traffic.

3. The method of claim 2, further comprising:
adjusting a rate of delivery of the content.

4. The method of claim 3, wherein adjusting further comprises:
determining whether a delivery goal associated with each campaign in the set of campaigns will be met.

5. The method of claim 2, further comprising:
determining a likelihood that a user has a higher probability to click-through content associated with the a campaign than content associated with a second campaign.

6. The method of claim 5, further comprising:
increasing a rate of delivery of the content for the first campaign to the user based on the likelihood.

7. The method of claim 5, further comprising:
decreasing a rate of delivery of the content for the second campaign to the user based on the likelihood.

8. The method of claim 2, further comprising:
delivering the content for each campaign in the set of campaigns based on a priority value assigned to each respective campaign.

9. The method of claim 8, further comprising:
adjusting the priority value for each campaign based on an expectation of the respective campaign meeting a content delivery goal.

10. The method of claim 8, wherein delivering the content includes:
determining the priority value based on a ratio between a percentage of time remaining in a duration of the campaign and a number of undelivered impressions of the content.

11. A method for forecasting impressions, comprising:
running an active content campaign that delivers content based on first targeting criteria;
receiving a request for a prospective content campaign associated with second targeting criteria; and
determining a content impression forecast for the first targeting criteria associated with the first campaign, the second targeting criteria, and a third targeting criteria associated with the first and second targeting criteria.

12. The method of claim 11, wherein determining includes:
determining the third criteria based on one or more relationships between the first and second criteria.

13. The method of claim 12, wherein the first, second, and third criteria are associated with at least one of a travel provider, a destination location, an embarkation location.

14. The method of claim 11, wherein determining includes:
determining a macro forecast for each of the first, second, and third targeting criteria; and
determining the impression forecast for each of the first, second, and third targeting criteria based on the determined macro forecast associated with a respective targeting criteria.

15. The method of claim 14, wherein determining the impression forecast for each of the first, second, and third targeting criteria includes:
determining the impression forecast based on at least one of the macro forecast, an indication of successful retrievals of identification information associated with users that access a document including the content, and a conversion factor value reflecting a relationship between visits to the document and a number of previous impressions of the content in the document.

16. The method of claim 14, wherein the macro forecast represents a number of predicted visits to a document including the content for a future period of time, and wherein the determining the macro forecast includes:
determining the macro forecast based on at least one of a type of the document, a type of industry associated with information included in the document, host expansion, a type of information delivery technique that provides information to one or more users that receive the content, a seasonality factor associated with the future period of time, and a growth rate value.

17. The method of claim 15, wherein the type of information delivery technique includes an electronic mail message delivery technique.

18. A method for allocating impressions of content on a document, the method comprising:
determining a first number of content impressions to be delivered for an active content campaign associated with first targeting criteria;
determining a second number of content impressions for a prospective content campaign associated with second targeting criteria; and
allocating impressions of the content, such that,
for the first targeting criteria, the first number impressions is allocated to the first campaign,
for the second targeting criteria, the second number of impressions is allocated to the second campaign, and
for a third targeting criteria reflecting a combination of the first and second targeting criteria, a third number of impressions is allocated to the first campaign and a fourth number of impressions is allocated to the second campaign.

19. A method for allocating impressions of content on a document, the method comprising:
allocating impressions for a first targeting criterion to a first campaign such that an impression forecast for the first targeting area is not exceeded;
allocating impressions for a second targeting criterion to a second campaign such that an impression forecast for the second targeting criterion is not exceeded;
allocating impressions, for a third targeting criterion associated with the first and second criteria, between the first and second campaigns such that an impression forecast for the third targeting criterion is not exceeded; and
delivering content to the document in accordance with the impression allocations.

20. The method of claim 19, delivering web content comprises:
determining whether an impression goal for each of the campaigns will be met based on the delivery of the content; and
adjusting the impression allocations to either the first or second campaigns based on a revenue value associated with each of the campaigns.

21. The method of claim 19, wherein the impression allocations are adjusted such that more revenue is generated based on the revenue values compared to revenue that would have been generated without the adjustment.

22. The method of claim 20, wherein the revenue values include a click-thru bonus associated with revenue produced based on a number of user selections of data included in the content.

23. A method for allocating impressions of content for a document, comprising:
receiving user visit records associated with accesses or attempted accesses of the document;
creating an impression opportunity matrix based on targeting criterion for at least one content campaign and the visit records;
creating an inventory map based on the impression opportunity matrix, the targeting criterion, and duration of the at least one content campaign; and
determining allocations of impressions of the content for the at least one content campaign based on the inventory map.

24. The method of claim 23, wherein creating an impression opportunity matrix includes:
searching the site visit records for the targeting criterion; and
modifying the impression opportunity matrix to reflect a result of the searching.

25. The method of claim 24, wherein the site visit records each include one or more data fields including information associated with a travel plan corresponding to a user that accesses the document and the searching includes:
searching the one or more data fields in each site visit record for the targeting criterion.

26. The method of claim 23, wherein creating an inventory map includes:
determining a number of impression opportunities for the targeting criterion based on a count of data included in the impression opportunity matrix.

27. The method of claim 26, wherein determining a number of impression opportunities includes:
determining a relationship between the number of impression opportunities and a total number of site visit records.

28. The method of claim 27, further including:
determining a number of impressions based on at least one of the relationship, a number of predicted visits to the document including the content for a future period of time, and for a future period of time, and a conversion factor value reflecting another relationship between visits to the document and a number of previous impressions of the content in the document.

29. A method for allocating impressions of content, comprising:
running an active content campaign having a first duration, a first impression goal, and a first campaign revenue rate;
receiving a second prospective content campaign having a second duration, a second impression goal, and a second campaign revenue rate;
determining a total duration period based on the first and second durations;
segmenting the total duration period into sub-periods;
determining a forecast of user access of the document for target criteria associated with the active and prospective campaigns, during each sub-period; and
allocating impressions of content to the document for the active and prospective campaigns based on the forecast such that increased revenue based on the revenue rate for each campaign is achieved.

30. The method of claim 29, wherein segmenting the total duration period comprises:
segmenting the total duration period such that neither an active or a prospective campaign begins or ends during a sub-period.

31. The method of claim 29, wherein determining a forecast of user access of the document comprises:
for each sub-period:
determining a sub-period seasonality value for the sub-period based on seasonality data for each day of a week included in the sub-period;
determining a monthly seasonality value for each month the sub-period is included;
determining the forecast for the sub-period based on the sub-period and monthly seasonality values.

32. The method of claim 29, wherein allocating impressions comprises:
allocating the impressions based on an allocation model with constraints preventing impression allocations from exceeding an impression goal for the active campaign.

33. A method for managing a delivery of content on a document, comprising:
determining that a visitor to a host maintaining the document has a higher likelihood to click-through content associated with a first campaign than content associated with a second campaign; and
increasing a delivery of the content associated with the first campaign to the visitor and decreasing the delivery of the content associated with the second campaign based on the determined likelihood.

34. A method for receiving content on a document, comprising:
accessing one or more documents over a network;
requesting, at a later time, content provided by a server in accordance with a process including:
maintaining historical data associated with the accessed one or more documents;
associating seasonality characteristics reflecting access trends for the one or more documents for a time period; and
allocating an impression of the requested content on a document based on an estimate of traffic for the one or more documents using the historical data and the seasonality characteristics.

35. A system comprising:
a client for requesting content on a document over a network;
a first computing entity for collecting historical visit data reflecting previous accesses or attempts to access at least one of a set of documents over a period of time, determining a relationship between one or more content delivery campaigns and targeting criterion based on the historical visit data, estimating future traffic for each of the set of documents, and allocating impressions of the content on the document for each of the one or more campaigns based on the estimated future traffic and the determined relationship;
a second computing entity for providing the content to the client over the network based on the impression allocations determined by the first computing entity.

36. A system for providing content on a document, comprising:
a first entity for requesting a number of impressions of content;
a second entity for allocating impressions of the content based on the request and forecasted impressions of the content for one or more targeting criterion; and
a third entity for providing the content on a document based on the allocated impressions.

37. The system of claim 36, wherein the one or more targeting criterion is based on one or more content delivery campaigns.

38. The system of claim 36, wherein the allocated impressions are further based on seasonality characteristics associated with previous accesses or attempts to access the document.

39. The system of claim 36, wherein the second entity adjusts the allocation of the impressions based on a determination of whether the requested number of impressions will be met based on a performance of the third entity in providing the content.

40. A computer-readable medium including instructions for performing a method, when executed by a processor, for allocating impressions of content in a system including a server configured to manage access to a set of documents, the method comprising:
storing historical data reflecting previous access or attempts to access at least one of the documents;
estimating future traffic for a document included in the set of documents using the stored historical data and seasonality characteristics associated with the previous access or attempts to access the at least one of the documents;
determining whether content associated with a targeting criterion may be allocated to a content delivery campaign;
allocating impressions of the content to the campaign based on the determination and the estimated future traffic; and
delivering the content for the campaign in accordance with the impression allocations.

41. The computer-readable medium of claim 40, wherein allocating impressions further comprises:
distributing impressions of the content to a set of content delivery campaigns based on the determination and the estimated future traffic.

42. The computer-readable medium of claim 41, further comprising:
adjusting a rate of delivery of the content.

43. The computer-readable medium of claim 42, wherein adjusting further comprises:
determining whether a delivery goal associated with each campaign in the set of campaigns will be met.

44. The computer-readable medium of claim 41, further comprising:
determining a likelihood that a user has a higher probability to click-through content associated with the a campaign than content associated with a second campaign.

45. The computer-readable medium of claim 44, further comprising:
increasing a rate of delivery of the content for the first campaign to the user based on the likelihood.

46. the computer-readable medium of claim 44, further comprising:
decreasing a rate of delivery of the content for the second campaign to the user based on the likelihood.

47. The computer-readable medium of claim 41, further comprising:
delivering the content for each campaign in the set of campaigns based on a priority value assigned to each respective campaign.

48. The computer-readable medium of claim 47, further comprising:
adjusting the priority value for each campaign based on an expectation of the respective campaign meeting a content delivery goal.

49. The computer-readable medium of claim 47, wherein delivering the content includes:
determining the priority value based on a ratio between a percentage of time remaining in a duration of the campaign and a number of undelivered impressions of the content.

50. A computer-readable medium including instructions for performing a method, when executed by a processor, for forecasting impressions, the method comprising:
running an active content campaign that delivers content based on first targeting criteria;
receiving a request for a prospective content campaign associated with second targeting criteria; and
determining a content impression forecast for the first targeting criteria associated with the first campaign, the second targeting criteria, and a third targeting criteria associated with the first and second targeting criteria.

51. The computer-readable medium of claim 50, wherein determining includes:
determining the third criteria based on one or more relationships between the first and second criteria.

52. The computer-readable medium of claim 51, wherein the first, second, and third criteria are associated with at least one of a travel provider, a destination location, an embarkation location.

53. The computer-readable medium of claim 50, wherein determining includes:
determining a macro forecast for each of the first, second, and third targeting criteria; and
determining the impression forecast for each of the first, second, and third targeting criteria based on the determined macro forecast associated with a respective targeting criteria.

54. The computer-readable medium of claim 53, wherein determining the impression forecast for each of the first, second, and third targeting criteria includes:
determining the impression forecast based on at least one of the macro forecast, an indication of successful retrievals of identification information associated with users that access a document including the content, and a conversion factor value reflecting a relationship between visits to the document and a number of previous impressions of the content in the document.

55. The computer-readable medium of claim 53, wherein the macro forecast represents a number of predicted visits to a document including the content for a future period of time, and wherein the determining the macro forecast includes:
determining the macro forecast based on at least one of a type of the document, a type of industry associated with information included in the document, host expansion, a type of information delivery technique that provides information to one or more users that receive the content, a seasonality factor associated with the future period of time, and a growth rate value.

56. The computer-readable medium of claim 55, wherein the type of information delivery technique includes an electronic mail message delivery technique.

57. A computer-readable medium including instructions for performing a method, when executed by a processor, for allocating impressions of content on a document, the method comprising:
determining a first number of content impressions to be delivered for an active content campaign associated with first targeting criteria;
determining a second number of content impressions for a prospective content campaign associated with second targeting criteria; and
allocating impressions of the content, such that,
for the first targeting criteria, the first number impressions is allocated to the first campaign,
for the second targeting criteria, the second number of impressions is allocated to the second campaign, and
for a third targeting criteria reflecting a combination of the first and second targeting criteria, a third number of impressions is allocated to the first campaign and a fourth number of impressions is allocated to the second campaign.

58. A computer-readable medium including instructions for performing a method, when executed by a processor, for allocating impressions of content on a document, the method comprising:
allocating impressions for a first targeting criterion to a first campaign such that an impression forecast for the first targeting area is not exceeded;
allocating impressions for a second targeting criterion to a second campaign such that an impression forecast for the second targeting criterion is not exceeded;
allocating impressions, for a third targeting criterion associated with the first and second criteria, between the first and second campaigns such that an impression forecast for the third targeting criterion is not exceeded;
delivering content to the document in accordance with the impression allocations.

59. The computer-readable medium of claim 58, delivering web content comprises:
determining whether an impression goal for each of the campaigns will be met based on the delivery of the content; and
adjusting the impression allocations to either the first or second campaigns based on a revenue value associated with each of the campaigns.

60. The computer-readable medium of claim 58, wherein the impression allocations are adjusted such that more revenue is generated based on the revenue values compared to revenue that would have been generated without the adjustment.

61. The computer-readable medium of claim 60, wherein the revenue values include a click-thru bonus associated with revenue produced based on a number of user selections of data included in the content.

62. A computer-readable medium including instructions for performing a method, when executed by a processor, for allocating impressions of content for a document, the method comprising:
receiving user visit records associated with accesses or attempted accesses of the document;
creating an impression opportunity matrix based on targeting criterion for at least one content campaign and the visit records;
creating an inventory map based on the impression opportunity matrix, the targeting criterion, and duration of the at least one content campaign; and
determining allocations of impressions of the content for the at least one content campaign based on the inventory map.

63. The computer-readable medium of claim 62, wherein creating an impression opportunity matrix includes:
searching the site visit records for the targeting criterion; and
modifying the impression opportunity matrix to reflect a result of the searching.

64. The computer-readable medium of claim 63, wherein the site visit records each include one or more data fields including information associated with a travel plan corresponding to a user that accesses the document and the searching includes:
searching the one or more data fields in each site visit record for the targeting criterion.

65. The computer-readable medium of claim 62, wherein creating an inventory map includes:
determining a number of impression opportunities for the targeting criterion based on a count of data included in the impression opportunity matrix.

66. The computer-readable medium of claim 65, wherein determining a number of impression opportunities includes:
determining a relationship between the number of impression opportunities and a total number of site visit records.

67. The computer-readable medium of claim 66, further including:
determining a number of impressions based on at least one of the relationship, a number of predicted visits to the document including the content for a future period of time, and for a future period of time, and a conversion factor value reflecting another relationship between visits to the document and a number of previous impressions of the content in the document.

68. A computer-readable medium including instructions for performing a method, when executed by a processor, for allocating content for delivery, the method comprising:
running an active content campaign having a first duration, a first impression goal, and a first campaign revenue rate;
receiving a second prospective content campaign having a second duration, a second impression goal, and a second campaign revenue rate;
determining a total duration period based on the first and second durations;
segmenting the total duration period into sub-periods;
determining a forecast of user access of the document for target criteria associated with the active and prospective campaigns, during each sub-period;
allocating impressions of content to the document for the active and prospective campaigns based on the forecast such that increased revenue based on the revenue rate for each campaign is achieved.

69. The computer-readable medium of claim 68, wherein segmenting the total duration period comprises:
segmenting the total duration period such that neither an active or a prospective campaign begins or ends during a sub-period.

70. The computer-readable medium of claim 69, wherein determining a forecast of user access of the document comprises:
for each sub-period:
determining a sub-period seasonality value for the sub-period based on seasonality data for each day of a week included in the sub-period;
determining a monthly seasonality value for each month the sub-period is included;
determining the forecast for the sub-period based on the sub-period and monthly seasonality values.

71. The computer-readable medium of claim 68, wherein allocating impressions comprises:
allocating the impressions based on an allocation model with constraints preventing impression allocations from exceeding an impression goal for the active campaign.

72. A computer-readable medium including instructions for performing a method, when executed by a processor, for managing a delivery of content on a document, the method comprising:
determining that a visitor to a host maintaining the document has a higher likelihood to click-through content associated with a first campaign than content associated with a second campaign; and
increasing a delivery of the content associated with the first campaign to the visitor and decreasing the delivery of the content associated with the second campaign based on the determined likelihood.

73. A computer-readable medium including instructions for performing a method, when executed by a processor, for receiving content on a document, the method comprising:
accessing one or more documents over a network;
requesting, at a later time, content provided by a server in accordance with a process including:
maintaining historical data associated with the accessed one or more documents;
associating seasonality characteristics reflecting access trends for the one or more documents for a time period; and
allocating an impression of the requested content on a document based on an estimate of traffic for the one or more documents using the historical data and the seasonality characteristics.

74. A system for allocating impressions of content in an environment including a server configured to manage access to a set of documents, the system comprising:
means for storing historical data reflecting previous access or attempts to access at least one of the documents;
means for estimating future traffic for a document included in the set of documents using the stored historical data and seasonality characteristics associated with the previous access or attempts to access the at least one of the documents;
means for allocating impressions of the content to the campaign based on a determination whether content associated with a targeting criterion may be allocated to a content delivery campaign and the estimated future traffic; and
means for delivering the content for the campaign in accordance with the impression allocations.

75. A system for forecasting impressions, comprising:
means for running an active content campaign that delivers content based on first targeting criteria;
means for receiving a request for a prospective content campaign associated with second targeting criteria; and
means for determining a content impression forecast for the first targeting criteria associated with the first campaign, the second targeting criteria, and a third targeting criteria associated with the first and second targeting criteria.

76. A system for allocating impressions of content on a document, the system comprising:
means for determining a first number of content impressions to be delivered for an active content campaign associated with first targeting criteria;
means for determining a second number of content impressions for a prospective content campaign associated with second targeting criteria; and
means for allocating impressions of the content, such that,
for the first targeting criteria, the first number impressions is allocated to the first campaign,
for the second targeting criteria, the second number of impressions is allocated to the second campaign, and
for a third targeting criteria reflecting a combination of the first and second targeting criteria, a third number of impressions is allocated to the first campaign and a fourth number of impressions is allocated to the second campaign.

77. A system for allocating impressions of content on a document, the system comprising:
means for allocating impressions for a first targeting criterion to a first campaign such that an impression forecast for the first targeting area is not exceeded;
means for allocating impressions for a second targeting criterion to a second campaign such that an impression forecast for the second targeting criterion is not exceeded;
means for allocating impressions, for a third targeting criterion associated with the first and second criteria, between the first and second campaigns such that an impression forecast for the third targeting criterion is not exceeded; and
means for delivering content to the document in accordance with the impression allocations.

78. A system for allocating impressions of content for a document, the system comprising:
means for receiving user visit records associated with accesses or attempted accesses of the document;
means for creating an impression opportunity matrix based on targeting criterion for at least one content campaign and the visit records;
means for creating an inventory map based on the impression opportunity matrix, the targeting criterion, and duration of the at least one content campaign; and
means for determining allocations of impressions of the content for the at least one content campaign based on the inventory map.

79. A system for delivering content on a document, the system comprising:
means for running an active content campaign having a first duration, a first impression goal, and a first campaign revenue rate;
means for receiving a second prospective content campaign having a second duration, a second impression goal, and a second campaign revenue rate;
means for determining a total duration period based on the first and second durations;
means for segmenting the total duration period into sub-periods;
means for determining a forecast of user access of the document for target criteria associated with the active and prospective campaigns, during each sub-period; and
means for allocating impressions of content to the document for the active and prospective campaigns based on the forecast such that increased revenue based on the revenue rate for each campaign is achieved.

80. A system for managing a delivery of content on a document, the system comprising:
means for determining that a visitor to a host maintaining the document has a higher likelihood to click-through content associated with a first campaign than content associated with a second campaign; and
means for increasing a delivery of the content associated with the first campaign to the visitor and decreasing the delivery of the content associated with the second campaign based on the determined likelihood.

81. A system for receiving content on a document, the system comprising:
means for accessing one or more documents over a network; and
means for requesting, at a later time, content provided by a server in accordance with a process executed by a processor including:
maintaining historical data associated with the accessed one or more documents;
associating seasonality characteristics reflecting access trends for the one or more documents for a time period; and
allocating an impression of the requested content on a document based on an estimate of traffic for the one or more documents using the historical data and the seasonality characteristics.
